(19) United States
(12) Patent Application Publication
(10) Pub. No.: US 2006/0217086 A1
(43) Pub. Date: Sep. 28, 2006

(54) Radio frequency power amplifier and method using a plurality of feedback systems

(75) Inventors: Kelly Mekechuk, Austin, TX (US); William Martin Snelgrove, Toronto (CA)

Correspondence Address: LAW OFFICES OF CHARLES W. BETHARDS, LLP, P.O. BOX 1622, COLLEYVILLE, TX, 76034, US

(73) Assignee: PulseWave RF, Inc.

(21) Appl. No.: 11/413,998

(22) Filed: Apr. 28, 2006

Related U.S. Application Data
(63) Continuation-in-part of application No. 11/089,834, filed on Mar. 25, 2005.
(60) Provisional application No. 60/675,614, filed on Apr. 28, 2005.

(51) Int. Cl. H01Q 11/12; H04B 1/04

(52) U.S. Cl. 455/126

(57) ABSTRACT

A radio frequency power amplifier and corresponding methods are arranged and configured to drive a resonant load with an output signal that includes AM or complex modulation from an input signal. The amplifier includes: a radio frequency switching stage with an output that is coupled to a resonant circuit and configured to provide the output signal when powered from a fixed voltage power supply; a feedback control system, coupled to the input signal and the output signal, and further comprising a sequencer configured to provide a sequencer output that is used to drive the radio frequency switching stage; and a second feedback system responsive to the sequencer output and configured to provide a second feedback signal that is coupled to the feedback control system, where the sequencer output has an OFF state that begins at a variable time corresponding to the input signal, the output signal, and the second feedback signal.

### RELATED APPLICATIONS

This application is a continuation in part of pending application titled RADIO FREQUENCY POWER AMPLIFIER AND CORRESPONDING METHOD, Ser. No. 11/089,834 by Snelgrove et al. filed on Mar. 25, 2005, which is hereby incorporated herein in its entirety by reference. This application also claims priority from Provisional Application Ser. No. 60/675,614, filed on Apr. 28, 2005 which is also hereby incorporated herein in its entirety by reference.

### FIELD OF THE INVENTION

This invention relates in general to communication equipment, and more specifically to radio frequency power amplifiers.

### BACKGROUND OF THE INVENTION

Radio-frequency power amplifiers are essential components of transmitters found in radio communication systems, and are deployed in various applications, such as mobile telephony, broadcast, wireless data networking, radiolocation and other fields. Generally, they function to make copies of their inputs, which are signals generated by other components of communication equipment, such as base transmitters, mobile devices, or the like, where the copies or output signals are powerful enough to propagate for appropriate distances. Two often conflicting requirements that constrain radio frequency power amplifiers are linearity and efficiency.

The linearity requirement or constraint on a radio frequency power amplifier is that it reproduces the form of its input signal faithfully. Small distortions in the form of the output signal relative to the input can cause the radio frequency power amplifier output signal to interfere with other radio services, in violation of regulatory requirements, or make it difficult or impossible to receive/demodulate the signal accurately. These distortions may be caused, for example, by the fact that the characteristics of the components of which a radio frequency power amplifier is composed (e.g. transistors) are non-ideal, e.g., vary with the electrical currents that they carry, which necessarily include the signal being reproduced. A conventional method (“class A operation”) of getting good linearity in this situation is to add a large “bias” current to signal currents so that current variations due to the signal are small in comparison.

The efficiency requirement or constraint means that the amplifier should not consume excessive power relative to its desired output power: thus, for example, an amplifier required to produce 10 Watts of output power may typically consume 100 Watts. This is often caused by the use of large bias currents, as described above, to improve linearity. The power (90 Watts in the example) “wasted” in this way causes many problems. For example, the power dissipated is manifested as heat, which has to be removed—often with large heat sinks and fans—before it causes temperature rises that damage the amplifier or other circuits. When equipment is battery-operated (e.g. in cell phones or in fixed installations (base transmitters) that are running on backup batteries during a power failure), battery size and hence weight and cost increases directly with power requirements.

Relatively efficient power amplifier circuits are known, and for radio frequency power amplifiers one of the more efficient is known as type or class “E”. These amplifiers attempt to operate their transistors as pure switches, which in principle dissipate (and hence waste) no power. Their operation depends on synchronization between closing the “switch” device and the “ringing” of a resonant load circuit, such that the switch is only driven closed at times when the voltage across it is almost zero. However, class E amplifiers pose problems. For example, since their output power is effectively set by a power supply voltage, they are difficult to amplitude-modulate and attempts to do so have resulted in both poor efficiency and poor linearity. The inability to modulate amplitude severely limits the applicability of class E amplifiers in most modem systems employing complex forms of modulation with varying amplitude or amplitude inverting signals.

Another switching power amplifier is known as class “D”. This amplifier architecture has been used for audio-frequency applications. Class D amplifiers in theory have low power dissipation (e.g. a switch does not dissipate power). In practice, Class D amplifiers are continually discharging capacitance (e.g., when turned on) and this can amount to significant power dissipation at radio frequencies.

Sigma delta technology is a known technique that allows feedback to be used to linearize, for example, class “D” switching amplifiers for audio-frequency use, but ordinarily this technology requires that switching events be synchronous to a fixed clock frequency. Typically, a sigma delta loop samples the output of a loop filter at a fixed rate that is independent of any input signal. This causes problems for class E radio frequency power amplifiers since their inputs need to be synchronized with a high frequency signal. Note that sigma delta and delta sigma are expressions that may be used interchangeably in this document.

### BRIEF DESCRIPTION OF THE DRAWINGS

The accompanying figures where like reference numerals refer to identical or functionally similar elements throughout the separate views and which together with the detailed description below are incorporated in and form part of the specification, serve to further illustrate various embodiments and to explain various principles and advantages in accordance with the present invention.

FIG. 1 depicts, in a simplified and representative form, a block diagram of a radio frequency power amplifier according to various exemplary embodiments;

FIG. 2 depicts, in a simplified and representative form, a more detailed block diagram of a radio frequency power amplifier according to one or more exemplary embodiments;

FIG. 3 illustrates, in a simplified and representative form, a more detailed block diagram of a radio frequency power amplifier including one embodiment of a sequencer according to one or more exemplary embodiments;

FIG. 4 depicts, in a simplified and representative form, a more detailed block diagram of a radio frequency power amplifier similar to that of FIG. 3 but including a mixer arrangement according to one or more exemplary embodiments;

FIG. 5 and FIG. 6 show representative embodiments of a second feedback system suitable for use in one or more radio frequency power amplifiers in accordance with various exemplary embodiments;

FIG. 7 depicts a representative block diagram of a generalized second feedback system suitable for use in one or more radio frequency power amplifiers in accordance with various exemplary embodiments;

FIG. 8 through FIG. 19 show various representative waveforms resulting from an experimental simulation of a radio frequency power amplifier in accordance with the embodiment depicted in FIG. 3;

FIG. 20 depicts, in a simplified and representative form, a block diagram of a loop filter suitable for use in one or more embodiments of a radio frequency power amplifier;

FIG. 21 depicts, in a simplified and representative form, a block diagram of another loop filter suitable for use in one or more embodiments of a radio frequency power amplifier;

FIG. 22 shows an exemplary state machine that represents an illustrative embodiment of a sequencer that may be used, for example, in FIG. 1 through FIG. 4;

FIG. 23 shows a further illustrative embodiment of a sequencer that may be used, for example, in FIG. 1 through FIG. 4; and

FIG. 24 depicts a flow chart of a method of providing a radio frequency signal with complex modulation according to one or more embodiments.

### DETAILED DESCRIPTION

In overview, the present disclosure primarily concerns communication equipment including radio frequency transmitters or amplifiers such as used in infrastructure equipment including base stations or in communications units. Such radio frequency amplifiers for example, may be found in cellular, two-way, and the like radio networks or systems in the form of fixed or stationary and mobile equipment. The fixed equipment is often referred to as base stations or transmitters and the mobile equipment can be referred to as communication units, devices, handsets, or mobile stations. Such systems and equipment are normally used to support and provide services such as voice and data communication services to or for such communication units or users thereof.

More particularly, various inventive concepts and principles are embodied in systems or constituent elements, communication units, transmitters and methods therein for providing or facilitating radio frequency amplifiers or power amplifiers with significant improvements in efficiency, linearity, signal to noise, and costs. Note that costs include costs associated with size and operational issues. The improvements are associated, for example, with power supplies and heat management issues as impacted by improved efficiency. The improvements also are reflected in lower component or production costs since the concepts and principles allow less expensive components, such as smaller transistors, to be used for higher power levels. The radio frequency power amplifiers advantageously use a feedback control system employing in some embodiments a version of a delta sigma modulator as well as a second feedback system thereby advantageously yielding a practical and readily producible power amplifier provided such amplifiers are arranged and constructed in accordance with the concepts and principles discussed and disclosed herein.

The communication systems and communication transmitters that are of particular interest are those that may employ some form of complex modulation and that may provide or facilitate voice communication services or data or messaging including video services over local area networks (LANs) or wide area networks (WANs), such as conventional two way systems and devices, various cellular phone systems including but not limited to, CDMA (code division multiple access) and variants thereof, GSM, GPRS (General Packet Radio System), 2.5G and 3G systems such as UMTS (Universal Mobile Telecommunication Service) systems, 4G OFDM (Orthogonal Frequency Division Multiplexed) systems, WiMax (IEEE 802.16), ETSI HiperMAN and variants or evolutions thereof.

The inventive concepts and principles described and discussed herein may be advantageously applied in any field where variable radio frequency power is required or appropriate. For example, certain medical, heating, lighting, and sensing applications may find the concepts and principles useful.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions.

Much of the inventive functionality and many of the inventive principles are best implemented with or in integrated circuits (ICs) such as custom ICs with some ICs using high speed and relatively high power technologies. It is expected that one of ordinary skill, notwithstanding possibly significant effort and many design choices motivated by, for example, available time, current technology, and economic considerations, when guided by the concepts and principles disclosed herein will be readily capable of generating such ICs with minimal experimentation. Therefore, in the interest of brevity and minimization of any risk of obscuring the principles and concepts according to the present invention, further discussion of such ICs, if any, will be limited to the essentials with respect to the principles and concepts of the exemplary embodiments.

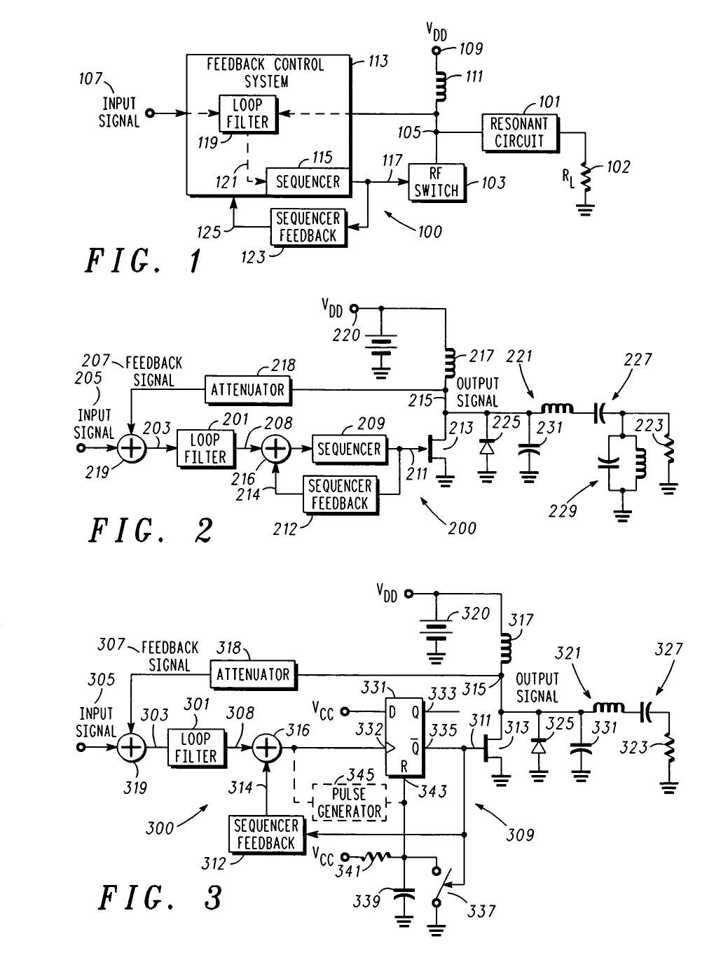

FIG. 1 through FIG. 4 illustrate various embodiments of radio frequency power amplifiers that are arranged and constructed and operate in an inventive manner. The inventors refer to this type of power amplifier as a class M power amplifier. These power amplifiers provide replication and amplification of an input signal that includes modulation, such as amplitude modulation, phase modulation or complex modulation (amplitude and phase modulation) in a linear and efficient manner. Generally these radio frequency power amplifiers utilize a novel arrangement of a switching stage driving resonant circuits and a feedback control loop that operates to induce or control timing associated with switching of the switching stage so as to linearly replicate an input signal including complex modulation as applied to a resultant load or amplifier output signal and to encourage the switching at times when on average the voltage across the switching stage is at a minimum. Heretofore it has not been possible to drive a radio frequency switching stage so as to reproduce modulation with both good linearity and large degrees of amplitude modulation or complex modulation.

These radio frequency power amplifiers can advantageously be implemented as one or more integrated circuits. For example, the switching stage can be implemented in a high power density gallium arsenide, gallium nitride, silicon based power device, or the like process. For the feedback systems and feedback control loop or system or one or more constituent elements, a known high frequency submicron silicon based process may be advantageous.

Referring to FIG. 1, a block diagram of a radio frequency power amplifier according to various exemplary embodiments will be discussed and described. FIG. 1 shows a radio frequency power amplifier 100 that is coupled to and arranged and configured to drive a resonant load including resonant circuit 101. The radio frequency power amplifier 100 will typically operate at frequencies from tens of Mega Hertz (MHz) to multiple Giga Hertz (GHz) and is generally utilized to amplify an input signal to provide a higher power load output signal. The resonant load as will be further described herein below is comprised of a combination of inductive and capacitive elements (the resonant circuit) and a load (shown as R_{L} 102). R_{L} 102 may include, for example, a harmonic filter, isolators, circulators, antenna, cable, or the like, that is driven by the resultant output or load output signal.

The radio frequency power amplifier 100 comprises a radio frequency switching stage 103 with an output 105 that is coupled to the resonant circuit 101 and configured to provide an output signal at output 105 with complex modulation, e.g., amplitude modulation (AM) and/or phase modulation (PM), corresponding to modulation of an input signal at input 107 when, for example, powered from a fixed voltage power supply, V_{DD} 109, via, e.g., a feed choke or inductor 111. The FIG. 1 embodiment of the radio frequency power amplifier 100 further comprises a feedback control system 113 that is coupled to the input (thus input signal 107) and the output 105 (thus output signal or one or more variants thereof as a feedback signal). Additionally a feedback system 123 is included. Note that the input terminal or node and the input signal may alternatively be referred to as input 107 or input signal 107. Similarly the output 105 and output signal at 105 may alternatively be referred to as output 105 or output signal 105.

The feedback control system 113 is configured to provide a sequencer output at output 117 that is used to drive the radio frequency switching stage 103. The sequencer output can be provided by, e.g., a sequencer 115 that is included with the feedback control system 113. Advantageously, the sequencer output has at least one state, e.g., an OFF state, with a starting time or which begins at a variable time that is determined by the feedback control system 113. The feedback system 123 is coupled and responsive to the sequencer output at output 117 (alternatively referred to as sequencer output 117) and provides a second feedback signal at 125 that is coupled to the feedback control system 113 in varying embodiments as further described below. The sequencer output 117 will correspond to one or more of the output signal, the input signal, the second feedback signal, a combination of the output, input, and feedback signals, or the like as will be further discussed below. The radio frequency switching stage 103 may be implemented in various forms; however it may be particularly advantageous when the switching stage together with the resonant circuit 101 is arranged as a radio frequency power amplifier similar to a class E configuration or in a class F configuration.

The radio frequency power amplifier 100 of FIG. 1 and specifically the feedback control system 113 in one or more embodiments further comprises a loop filter 119. The loop filter 119 is responsive to the input signal and the output signal or first feedback signal via the inter coupling as shown and the loop filter is configured to provide a filtered signal at 121. The sequencer 115 is responsive directly or indirectly to the filtered signal at 121. For a given embodiment of a sequencer there will normally be a defined relationship between the operation of the sequencer and the output or filtered signal from the loop filter as well as the second feedback signal, e.g. rising edge zero crossings of the loop filter signal, specifically input to the sequencer, trigger the sequencer. The loop filter may be, e.g., an nth order (n=1, 2, 3, . . . ) band pass filter, or an nth order low pass filter depending on other particulars of the feedback control system.

For example, if the input signal is at or centered at a desired carrier frequency (e.g., 900 MHz, 2.4 GHz, etc) or some other frequency, such as an intermediate frequency, that is above 0 hertz, a band pass filter may be advantageous. Alternatively if the input signal is centered at 0 hertz or a relatively low frequency, e.g. a base band frequency, relative to the carrier frequency, a low pass filter can be more useful. In the latter case or where the input signal is not centered at the carrier frequency, a mixer arrangement can be employed to provide a first feedback signal, e.g., input signal to the filter, where the feedback signal corresponds to the output signal as down converted by the mixer arrangement and provide a sequencer input corresponding to the filtered signal, i.e., in some embodiments a combination of the input signal and the feedback signal, as up converted by the mixer arrangement.

It is further noted that the second feedback signal can be directly combined with the filtered signal, or used as an additional input to the loop filter or may be used to affect or modify or otherwise change the filtered signal and thus impact the sequencer input and therefore sequencer output. These alternatives will be described below in additional detail with reference to, e.g., FIG. 2-7. Without loss of generality portions of the following discussion will refer to an embodiment where the second feedback signal is combined with the filtered signal from the loop filter with the resultant signal used as the sequencer input. In these instances the second feedback signal is coupled to the input to the sequencer. It should be understood that one or more alternative embodiments use the second feedback signal 125 to otherwise affect or modify the filtered signal from the loop filter 119, i.e., the second feedback signal can be one component of the input signal for the filter or can be coupled directly to some portion of the filter and thus affect the filtered signal.

Referring to FIG. 2, a more detailed block diagram of a radio frequency power amplifier according to one or more exemplary embodiments will be discussed and described. In FIG. 2, a radio frequency power amplifier 200 comprises as part of a feedback control system, a loop filter 201 with an input 203 coupled to a signal corresponding to an input signal 205 and a first feedback signal 207. Note that the feedback signal 207 and the terminal or node where the feedback signal is found will alternatively be referred to by reference numeral 207. In this embodiment where the input signal has (or is centered about a frequency equal to) the desired output carrier frequency, the loop filter 201 will normally be a relatively high gain nth order band pass filter, with n=1, 2, 3, . . . Further included is a combiner 216 (analog adder) that is coupled to an output terminal 208 and responsive to a filter output or filtered output signal from the loop filter 201 and a second feedback signal at 214 provided by a second feedback system 212, e.g., sequencer feedback. Further included and depicted is a sequencer 209 that is configured to provide a sequencer output at output 211. The sequencer output has at least one state, e.g., an OFF state, with a starting time that corresponds to the output signal from the combiner 216, i.e., filter output and second feedback signal as will be further discussed below.

Additionally included is a radio frequency switching stage 213 that is driven by the sequencer output and configured to provide an output signal at 215. As shown in one or more embodiments the switching stage is supplied DC (direct current) power from a constant voltage source V_{DD} 220 via a feed choke or inductor 217. The output signal is coupled via an attenuator 218 back to be combined with the input signal at summer 219. Thus, the feedback signal 207 corresponds to the output signal 215. The summer 219 provides the signal at 203 to the loop filter 201, i.e., the signal coupled to the input of the loop filter can be an error signal corresponding to an algebraic combination of the input signal and the feedback signal. The radio frequency switching stage in one or more embodiments is a field effect transistor (FET or JFET) but may also be a bipolar transistor or the like. In some embodiments the FET or JFET is formed using known GaAs (gallium arsenide), GaN (gallium nitride), LDMOS (Laterally Diffused Metal Oxide Semiconductor) process technology as noted earlier. Note that while the switching stage is shown as one transistor a plurality of transistors may be used essentially in parallel to perform the switching function. Note also that appropriate circuitry, such as additional gain stages will be needed, either as part of the sequencer or switching stage in order to insure that the switching stage is properly driven.

Those of ordinary skill will recognize that if the sequencer 209 provides a quantized output, i.e. a finite number of fixed levels or states, the amplifier of FIG. 2 (or FIG. 1 and others) has an architecture similar to a delta sigma (alternatively sigma delta) converter. However, the operation and function of the sequencer is distinctly different for a number reasons including for example asynchronous operation or quasi asynchronous operation (i.e., not synchronized to a fixed clock) where the states of the sequencer correspond to states of the output signal or first feedback signal, input signal, and second feedback signal or output from the loop filter and second feedback signal.

The output signal at 215 is applied to a resonant circuit 221 and via the resonant circuit 221 to a load 223. Placed across the switching stage 213 is a diode (catch or snub diode) 225 that is configured and operates to clamp the output signal to a voltage that is non-negative, i.e., essentially at ground potential. Note that diode 225 may be a parasitic diode, e.g., source to substrate diode or the like for the switch 213, or the switch itself may turn on or be turned on when the voltage is at or below ground. The resonant circuit 221 includes a series resonant inductor capacitor pair 227 that couples the output signal as filtered by the series resonant pair 227 to the load 223. Across or in parallel with the load is a parallel resonant inductor capacitor pair 229. Further included in the resonant circuit 221 is a capacitor 231 that is coupled in parallel with the switching stage 213. Those of ordinary skill will appreciate that the capacitor 231 will include at least a parasitic capacitance of switching stage 213 and depending on the particular embodiment the capacitor 231 may only include the parasitic capacitance.

Those of ordinary skill in the field will recognize the switching stage 213 (and others in other figures) together with the resonant circuit as shown and described can be arranged in or similar to a class F configuration. Alternative embodiments of the switching stage and the resonant circuit can be arranged in a known class E configuration (for example, eliminate the parallel inductor capacitor pair 229). Other architectures for class F or class E exist and may also be utilized. Class E and F power amplifiers while taking advantage of the open or short circuit zero power dissipation characteristics also recognize that in practice the switching stage takes a finite time period to change between these states and if both voltage and current are non-zero during the time period between states, power will be dissipated. Such power amplifier architectures attempt to avoid dissipating energy stored in the parasitic capacitance (at least part of capacitor 231) of the switching device or stage by insuring this energy is provided to or comes from the resonant circuit, e.g., resonant circuit 221, rather than being dissipated in the switching device 213. Thus these configurations strive to perform switching between states (ON/OFF) during those times when the voltage of the output signal, i.e., signal across the switching device, is ideally zero volts and furthermore if possible when the derivative of this voltage is also zero, i.e. switching currents will also be zero.

In practice with class E or class F and others these conditions can only be approached and then only when the output signal is at or nearly at a predetermined amplitude or power level for a given V_{DD} level. In contrast, the radio frequency amplifier disclosed herein and in related applications, i.e., class M power amplifier, allows the amplitude or power level of the output signal over a frequency band of interest (in-band) to vary, e.g., in accordance with AM modulation requirements as reflected by modulation on an input signal, and encourages or controls the switching stage to switch between states at appropriate times which approach the ideal situation, i.e., with a voltage across the switching device that is relatively low and approaching or at zero as often as possible. For example, where, as here, the radio frequency switching stage is configured to drive a resonant load and controlled by the feedback control system, the switching stage can be configured to switch ON responsive to the sequencer output so that over a multitude of switch ON events an average voltage, e.g., root mean square of the voltages, imposed on the resonant load and across the switching stage at the switch ON event is less than ½, typically less than ¼ and often less than 1/10 of a maximum voltage imposed on the resonant load, e.g., in practice a voltage approaching the specified breakdown voltage associated with the radio frequency switching stage.

Furthermore, when amplitude modulation must be reproduced or included in the output signal, known class E and class F configurations are typically inefficient and exhibit poor linearity, i.e., known architectures simply do not work as a linear radio frequency power amplifier. In stark contrast, the radio frequency power amplifiers, i.e. class M radio frequency power amplifiers, as disclosed herein and in related applications are arranged such that the radio frequency switching stage as driven by the sequencer output is configured to provide an output signal including complex modulation (AM or PM) as imposed on the input signal while, for example, powered from a constant voltage power supply with reasonable efficiency and linearity performance. Thus the present radio frequency switching stage as driven by the sequencer output is configured to provide an output signal that includes an amplified replica of the input signal over an input signal bandwidth or relevant input signal bandwidth, where the input signal includes at least one of amplitude modulation and phase modulation.

Referring to FIG. 3, a more detailed block diagram of a radio frequency power amplifier 300 including one embodiment of a sequencer will be discussed and described. The radio frequency power amplifier 300 functionally includes many of the same entities as FIG. 1 or FIG. 2 and thus this description will not dwell on most of them. The radio frequency power amplifier 300 includes a loop filter 301 (normally nth order band pass filter in this embodiment) with an input 303 coupled to a signal corresponding to an input signal 305 and a feedback signal 307. Further included is a summer or combiner 316 and a sequencer 309 where the combiner is responsive to a second feedback signal at 314 from a feedback system, e.g. sequencer feedback 312, and a filter output, e.g., via output/input 308, from the loop filter 301 or loop filter output signal. The sequencer 309 is configured to provide a sequencer output at output 311, where the sequencer output has an OFF state with a starting time that corresponds to the filter output signal and the second feedback signal (i.e., there is a defined relationship between the filter output signal plus second feedback signal and operation of the sequencer and thus sequencer output). Additionally included is a radio frequency switching stage 313 driven by the sequencer output and configured to provide an output signal at output 315 that is coupled via the attenuator 318 to the summer 319. Thus, the feedback signal 307 corresponds to the output signal. Note the OFF state corresponds specifically to switching stage 313 being opened or in a high impedance state, i.e., OFF state.

The radio frequency switching stage 313 can be powered from a constant voltage supply 320, e.g., 10 volts, via a feed inductor 317 and is coupled to and drives a resonant circuit 321 comprised of a series resonant inductor capacitor pair 327 and capacitor 331 that operates to filter the output signal and drive a load 323. A catch or snub diode 325 is located as shown in parallel with the switching stage. The switching stage 313 with the resonant circuit 321 will be recognized as a radio frequency amplifier that can as known be arranged in or similar to a class E configuration with appropriate values of the inductors and capacitors given a frequency of interest.

The sequencer 309 further comprises a flip flop, such as a D flip flop 331 or other appropriately arranged flip flop or the like that is clocked, for example, from the combiner output at input 332. The sequencer 309 is configured to provide the sequencer output in the OFF state (low voltage state) when triggered by the combiner 316, i.e., the OFF state has a starting time that corresponds to the combiner output. Note in this embodiment, when the output signal at 308 from the loop filter 301 plus the second feedback signal 314 crosses a switching threshold at a clock input 332 of the D flip flop, the Q output 333 goes high (Vcc since the D input is tied to Vcc) and the Q bar output 335 goes low. When the Q bar output 335 or sequencer output at 311 goes low (OFF state), a switch 337 is opened.

The open switch 337 allows a capacitor 339 to begin charging toward Vcc through a resistor 341. The junction of the capacitor and resistor is coupled to a Reset input 343. When the capacitor has charged to the Reset threshold of the D flip flop 331 at a time determined by the RC time constant of resistor 341 and capacitor 339, the D flip flop will be reset and the Q bar output will go high, the switch 337 will be closed holding the Reset input at a low potential, and the sequencer will thus provide the sequencer output at 311 in an ON state (switching stage 313 is ON) after a time lapse determined by the Reset signal (in this embodiment the RC time constant) for the D flip flop. This sequencer 309 is often referred to as an edge triggered one shot. It has been found that a time lapse on the order of a half cycle of the radio frequency carrier can be an appropriate time duration for the OFF state, e.g., at 1000 MHz, approx 0.5 nanosecond. After the D flip flop has been reset, when the combiner output again goes high, the sequencer 309 will again provide an output in the OFF state.

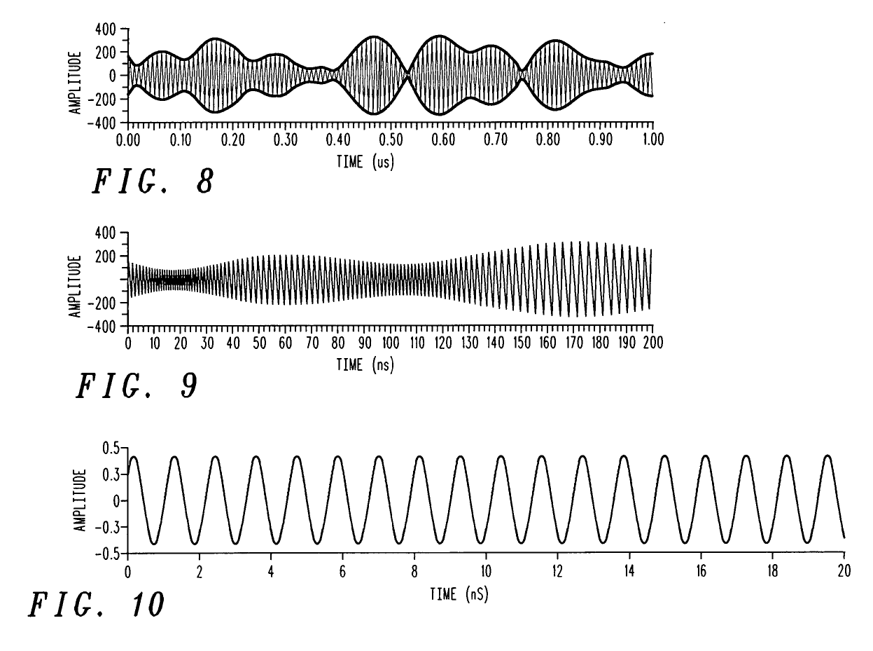

Note that when the sequencer output is in the OFF state, the switching stage is an open circuit, i.e., stage is turned OFF, and the resonant circuit 321 may be charging up through the feed inductor 317 or the inductor capacitor pair may be charging up capacitor 331 thus causing a positive going pulse in the output signal at 315. Conversely when the sequencer output is in the ON state, the switching stage is a short circuit, i.e., the switching stage is turned ON, the output signal at 315 is approx zero volts, and the resonant circuit 321 may be discharging through the switching stage. These and other relationships between waveforms in an embodiment of the radio frequency power amplifier similar to FIG. 2 will become clearer with the discussion of simulation waveforms below where FIG. 8 through FIG. 19 are referenced. The specific voltages associated with ON or OFF states can be determined by specific technologies that are being utilized for the sequencer as well as the switching stage(s). For example, when depletion mode devices are used for the switching stage the OFF state for the switching device can be approximately −2 volts while the ON state can be between 0 and 0.5 volts. The sequencer and various driver stages will need to be fashioned to provide the appropriate drive signal to the switching stage(s).

For high-frequency operation, an appropriate sequencer operates in an asynchronous manner, i.e. there is no clock as in conventional architectures. Note that for reasonable efficiency when reproducing input signals it is necessary that the sequencer output produce a drive signal for the class E/F amplifier that is compatible with its requirements, e.g., switching at or near zero voltage, etc. This normally means that the sequencer will need to switch at or near the carrier frequency and that the sequencer will need to vary or modulate the timing of its switching decisions with a resolution that is fine in comparison with the period of the carrier, e.g. at ⅛ or smaller increments of the period. This is in stark contrast to conventional feedback architectures, such as sigma-delta architectures, which are synchronized to a clock that is independent from and thus whose phase relationship to the carrier is essentially random.

Thus, the sequencer 309 (and 209, 115) should, in embodiments where efficiency is desired, be configured to provide the sequencer output with a second state, e.g., ON state, that has a starting time corresponding to, e.g., at or near to or on average at or near to, a voltage minimum for the output signal as will become more evident with the review of the simulation waveforms below. As discussed above, the sequencer in certain embodiments is configured to provide the sequencer output where the OFF state has a minimum time duration (e.g., determined by the RC time constant) and the sequencer output further has an ON state having a variable time duration (in the described and various embodiments the ON state once it begins will last until the output of the combiner 316, i.e., output of the loop filter as modified in accordance with the second feedback signal, triggers the D flip flop). In the embodiment noted above, the sequencer is configured to provide the sequencer output with an OFF state having a predetermined time duration, i.e., a time duration determined by the RC time constant.

Note that other embodiments may use a sequencer that is configured to provide the sequencer output with an OFF state having a variable time duration where the variable time duration is equal to or greater than the minimum time duration. For example a pulse generator 345 (optional) that is triggered by a positive going output or some predetermined state from the combiner or loop filter to provide a negative going pulse at the Reset input and otherwise provide an open circuit will discharge capacitor 339 and thus provide a variable time duration for the OFF state. Note that the switch and RC circuit coupled to the Reset input of the D flip flop may be viewed as an edge triggered one shot, where as with the addition of the pulse generator 345, this may be viewed as an edge triggered and re-triggerable one shot. Those of ordinary skill will appreciate that various circuit architectures can be utilized to perform the functions of the pulse generator.

Thus in the sequencer using the optional pulse generator 345, the sequencer can be configured to provide the sequencer output in the OFF state when the filter output as modified by or in accordance with the second feedback signal 314 corresponds to a predetermined state (the clock level for the D flip flop) and to provide the sequencer output in the ON state after a time lapse that is variable and that corresponds to the minimum time duration starting at the last occurrence of the predetermined state. As noted above, the sequencer is configured to provide the sequencer output asynchronously, i.e., the sequencer is clocked by the combiner output, i.e., loop filter output as modified by the second feedback signal or the control loop may be viewed as self clocked. Note that the sequencer may also be viewed as clocked by various signals, e.g. the output signal (drain voltage) as that ultimately determines the filter output signal, for a given input signal.

In a further alternative embodiment, not specifically depicted, an envelope detector monitors the input signal and when an envelope level of around 20% of the peak envelope is detected, the envelope detector or functionality responsive thereto will operate a switch. The switch would add an additional capacitor in parallel with capacitor 339. If the additional capacitor had a capacitance that was, e.g., 2 times that of capacitor 339, the time constant would be about 3 times the initial time constant and this would extend the OFF state to approximately 3 times the original. The net result is the duty cycle of the switching stage is reduced when signal levels are low, the current in the feed inductor is reduced, and this ultimately results in reducing power consumption of the switching stage.

Referring to FIG. 4, a more detailed block diagram of a radio frequency power amplifier similar to that of FIG. 2, FIG. 3, etc but including a mixer arrangement will be discussed and described. In FIG. 4, the radio frequency power amplifier 400 includes in addition to the sequencer 409 (similar to, e.g., sequencer 309), switching stage 313, resonant circuit 321, attenuator 318, etc., a mixer arrangement 401 and a feedback network or system 419. The sequencer 409, switching stage 313, resonant circuit 321, attenuator 318, etc. operate in accordance with previously discussed principles and concepts although they may be adjusted, etc. to accommodate the particulars associated with the embodiment of FIG. 4. The radio frequency power amplifier 400 of FIG. 4 is arranged and constructed to receive an input signal 403 at a base band frequency, such as zero hertz or another intermediate frequency that is typically relatively low compared to the carrier frequency of the signal that is to be transmitted, frequency translate or up convert the input signal to a carrier frequency and amplify the resultant up converted signal to provide an output signal that is filtered and coupled as a resultant signal to the load 323. The output signal will be at the carrier frequency and will include modulation corresponding to the input signal. Note that the input signal 403 is a complex signal with I (in phase) and Q (quadrature) components where the double lines in FIG. 4 are used to denote complex signals having I and Q components.

The mixer arrangement 401 includes linear I/Q mixers 405, 407 (e.g., Gilbert cell arrangements) and is configured to provide the feedback signal 409, where the feedback signal corresponds to the output signal at 315 as frequency translated or down converted to the frequency of the input signal by the mixer arrangement or more specifically mixer 405. Note that under appropriate circumstances mixers other than Gilbert cells can be used. The feedback signal 409 is combined with the input signal 403 in the summer 411 with the resultant complex signal coupled to a loop filter 413. The complex conversion is a multiple mixer complex conversion providing two outputs coupled to two inputs of the filter so as to provide image rejection without undue delay as discussed in Section 9 of a University of Toronto, Department of Electrical Engineering Doctoral Thesis titled Intermediate Function Synthesis, authored by Snelgrove in December 1981, hereby incorporated herein. The mixer arrangement further provides a sequencer input at input 432 that corresponds to the filter output or output signal from the loop filter 413 as frequency translated or up converted by the mixer arrangement 401, specifically mixer 407 to the carrier frequency, and as modified in accordance with the second feedback signal at 420. Note that only one of the complex signal components (I or Q) from mixer 407 is needed to drive the sequencer or alternatively a combiner 421. In particular, the Q or imaginary component or alternatively the I or real component can be utilized; however the sequencer could be driven by a complex signal.

Thus the sequencer input or input signal corresponds to a combination of the input signal and the feedback signal as filtered and up converted. Note that the mixer arrangement may be viewed as part of the feedback control system of FIG. 1. Generally when the input signal is at base band, i.e. centered at DC or zero frequency, the loop filter may be advantageously implemented as a low pass filter and when the input signal is centered at another, e.g., intermediate, frequency the loop filter is normally implemented as a band pass filter centered at the intermediate frequency. Since the filter is handling complex signals both the I and Q component will need to be filtered prior to presentation to the mixer 407. In either situation the loop filter is configured to filter the combination of the input signal and the feedback signal. Using the mixer arrangement, while adding an apparent level of complexity, allows the loop filter to be implemented at a lower frequency and thus may allow for a more exacting or higher precision loop filter to be implemented/provided at lower costs. Using frequency translation in the feedback control system allows the input signal to be presented at base band and thus may eliminate the frequency translation at some other place in a typical transmitter lineup.

The mixer arrangement in addition to the mixers 405, 407 includes a local oscillator 415 that provides a local oscillator signal at a frequency equal to the carrier plus or minus the center frequency of the input signal. Thus if the input signal is at or centered at DC the local oscillator oscillates at the carrier frequency and otherwise at the carrier frequency plus or minus the intermediate frequency. The local oscillator signal is coupled to both mixers, however the signal coupled to mixer 407 is time-shifted or phase delayed by the phase shifter 417. The phase shifter 417 in some embodiments delays the oscillator signal to mixer 407 by approximately one-quarter cycle (at the carrier frequency) and forms the conjugate phase (the sign of the gain for the Q channel in the down conversion mixer 405 is opposite to the sign for the Q channel in the up conversion mixer 407) for the oscillator signal applied to the mixer 407 as compared to the signal applied to the mixer 405.

The time shift can be selected or adjusted to compensate for time delays in the feedback control system or loop or otherwise improve performance results in parameters such as signal to noise, linearity (noise plus distortion), stability, or the like. One approach for varying the time shift can utilize the second feedback system 419, which is responsive to the output signal from the sequencer and provides a control signal or second feedback signal at an output 420 to the phase shifter 417. This control or feedback signal can be used to provide or add to a phase shift to the local oscillator signal driving mixer 407. Thus the phase shift varies in accordance with the second feedback signal. This phase shift can be in lieu of or in addition to a fixed phase shift that was provided by the phase shifter 417. Note that the output of mixer 407 is the loop filter output signal as up converted or frequency translated and as modified in accordance with the second feedback signal. The second feedback signal can also be used in a further embodiment to modify or change the output signal (frequency translated loop filter output signal) from mixer 407 by coupling the second feedback signal 420 to combiner 421 where it is added to the output of the mixer 407 with the combiner then providing an input signal to the sequencer 409. The latter approach for affecting the signal at the input to the sequencer is similar to the approaches discussed with reference to, e.g., FIG. 2-3.

Thus the radio frequency power amplifier of FIG. 4 includes a feedback control system (401, 411, 413, 409) coupled to a signal corresponding to an input signal 403 and a first feedback signal 409 which is configured to provide a sequencer output at 410. Further included is a second feedback system 419 that is responsive to the sequencer output and configured to provide a second feedback signal at 420 that is coupled to the feedback control system, e.g., at phase shifter 417 or combiner 421; where the sequencer output has at least one state with a starting time that is determined by the feedback control system; and a radio frequency switching stage 313 that is driven by the sequencer output and configured to provide an output signal, e.g., at 315, where the first feedback signal corresponds to the output signal. The radio frequency power amplifier of FIG. 4 further comprises a mixer arrangement 401 that is configured to provide the feedback signal, where the feedback signal further corresponds to the output signal as frequency translated by the mixer arrangement. The mixer circuits or arrangement furthermore provides a sequencer input 432 that corresponds to the filter output as frequency translated by the mixer arrangement and as modified, e.g., via the phase shifter or via the combiner, in accordance with the second feedback signal. The loop filter 413 can be a low pass filter or a band pass filter depending on the center frequency of the input signal.

Time domain simulations of the radio frequency power amplifier 400 of FIG. 4 have been conducted using PC based circuit design and simulation software. For illustrative purposes, the system that was simulated produced a modulated output signal nominally centered at 100 MHz and processed an information signal comprised of 4 sinusoids arbitrarily spaced across a bandwidth of 1.25 MHz. The 4 sinusoid information signal is representative of the system processing an arbitrary wideband signal having a 6 dB peak-to-average power ratio. In addition, the switching stage 313 was a GaAs FET having a 9 mm gate width, and V_{DD} 316 was set to 12 volts. During the course of executing the simulations, system performance, i.e. signal-to-noise ratio, output load power efficiency and absolute output load power, was optimized by changing component values in an iterative manner through the application of electrical engineering principles. A signal-to-noise ratio of approximately 50 dB over a 1.25 MHz bandwidth, a power efficiency of 27% and an output load in band signal power of 3.8 Watts was achieved by setting the respective components to the values noted below. The element values were; a feed inductor 317 of 100 nH (nano-henrys), a capacitor 331 of 100 pF (pico-farads), a series resonant inductor capacitor pair 321 of 11 nH and 250 pF, respectively, and a load 323 of 3 Ohms.

In contrast to these results, a Class A amplifier in an equivalent comparison circuit, with the same input signal and output signal power and linearity would achieve a power efficiency of approximately 7 to 8 percent. Note that further optimization work may yield different performance results and component values. One of ordinary skill will realize that more detailed models may be required and that different performance values may be obtained, for example, at higher frequencies.

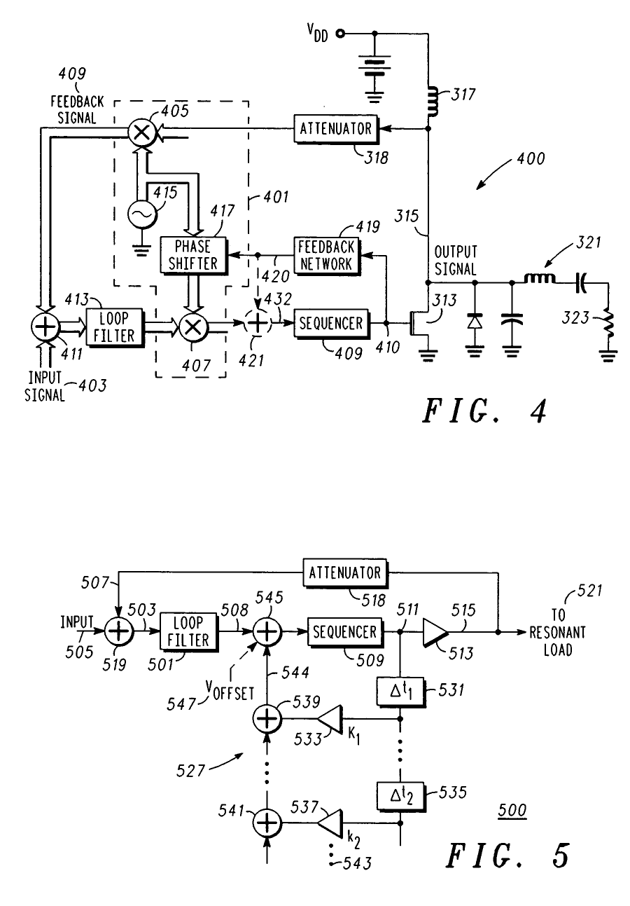

Referring to FIG. 5 a representative radio frequency power amplifier including a more detailed diagram of a second feedback system in accordance with various exemplary embodiments will be discussed and described. In FIG. 5, a radio frequency power amplifier 500 is similar to and operates similar to the various other power amplifiers that have been described. The radio frequency power amplifier comprises as part of a feedback control system, a loop filter 501 with an input 503 coupled to a signal corresponding to an input signal 505 and a first feedback signal 507. Note that the feedback signal 507 and the terminal or node where the feedback signal is found will alternatively be referred to by reference numeral 507. Further included is a combiner 545 (analog adder) that is coupled to an output terminal 508 and responsive to a filter output or filtered output signal from the loop filter 501 and a second feedback signal at 544 provided by a second feedback system 527, e.g., sequencer feedback. Further included and depicted is a sequencer 509 that is configured to provide a sequencer output at output 511. The sequencer output has at least one state, e.g., an OFF state, with a starting time that corresponds to the output signal from the combiner 545, i.e., filter output and second feedback signal as will be further discussed below. Additionally included is a radio frequency switching stage or power stage 513 that is driven by the sequencer output and configured to provide an output signal at 515. The output signal at 515 is coupled to a resonant load 521 and is further coupled via an attenuator 518 back to be combined with the input signal at summer 519.

The second feedback system 527 as well as the feedback systems 123, 212, 312, 419 of FIG. 1-FIG. 4 and can be implemented in various manners. In this instance the second feedback system comprises a feedback network coupled from the sequencer output to the sequencer input via the combiner 545. In one embodiment, as depicted in FIG. 5 the second feedback system 527 comprises one or more delay stages with outputs coupled to a corresponding one or more gain stages with each of the gain stages having an output, where the second feedback signal corresponds to a combination of the signal at the output of each of the one or more gain stages. More specifically FIG. 5 shows a delay stage 531 that is coupled to and responsive to the sequencer output 511 and operates to present a delayed version of the sequencer output to gain stage 533.

The output of delay stage 531 in alternative embodiments can be coupled to a further delay stage 535 with the output of that delay stage 535 coupled to a corresponding gain stage 537. The basic architecture of delay stages and gain stages can be repeated if desired as indicated by the dotted lines 543. Generally, the one or more delay stages, i.e., delay stage 531, 535, etc., may advantageously be implemented as a tapped delay line with each tap coupled, respectively, to a different one of the one or more gain stages, i.e., gain stage 533, 537, etc. When the sequencer provides a 2 state output, i.e., with a high or ON state and a low or OFF state, the delay stages can be implemented as a series coupled array of logic gates or buffers with each buffer or gate adding a characteristic delay. For example in one embodiment, a series coupled group of sixteen buffers has been used for the delay stage.

The output of the gain stages 533, 537, etc. are added together via one or more adders or combiners 539, 541, etc. to provide the second feedback signal at 544. Note that in embodiments of the second feedback system that use only one delay stage and one gain stage, e.g., delay stage 531 and gain stage 533, the output of gain stage 533 is the second feedback signal and this signal can be coupled directly to combiner 545. The feedback system or network 527 and others can take many forms, however normally at least one and often all of the one or more delay stages and at least one and often all of the corresponding one or more gain stages is operating asynchronously or continuously in the time domain rather than in a clocked mode, i.e., the output is a function of the input for any instant in time. Other gain stages or delay stages may operate in a discrete time mode (i.e., output is a function of input at discrete times as determined by a clock). The delay stages essentially provide a memory function in that a second feedback signal is representative of the sequencer output at some past instant (the amount of the delay) in time.

FIG. 5 also illustrates another embodiment of a radio frequency power amplifier that can provide appropriate performance results in some situations. This embodiment includes a biasing system 547 that is configured to couple an offset signal (V_{OFFSET}) to the input of the sequencer, resulting in the sequencer output changing states in accordance with the offset signal and the filter output signal. The biasing system or V_{OFFSET} can be used in lieu of or in addition to the second feedback system. A typical value for V_{OFFSET} that has been simulated with reasonable results in one power amplifier system is 10% of the rms voltage at the filter output 508.

Various experimental and simulation efforts have shown favorable performance when the delay stages add a delay around one half cycle, e.g., ranging from 0.25 to 0.75 cycle at the carrier frequency, e.g., at 1000 MHz—approximately 0.25 to 0.75 nano-second (ns) of delay for each delay stage. The gain of the gain stages are typically fractional values that will vary depending, e.g., on the typical output level of the loop filter as well as output level of the delay stages. For example, with a 1 volt rms level at the output of the loop filter and a signal varying from +1 volt to −1 volt at the output of the delay stages, a typical value for the first gain stage 533 can be 0.15 ranging from 0.05 to 0.35, and can be either positive or negative (180 degree phase shift). Some embodiments perform well when gain stage 533 is a negative value (180 degree phase shift), e.g., −0.15, and gain stage 537 is a positive value, e.g., 0.1, with alternating stages negative and positive. It can be expected that for any particular implementation, these values will need to be experimentally optimized to account for various factors such as other loop delays within the power amplifier as well as other factors, e.g. loop filter, sequencer, the switching device and the load that the switching device is driving.

Referring to FIG. 6 an alternative diagram of a second feedback system suitable for use in one or more radio frequency power amplifiers in accordance with various exemplary embodiments will be discussed and described. The second feedback network or system of FIG. 6 includes a delay stage 601 coupled to the sequencer output signal at 511 where the delay stage couples a delayed version of the sequencer output to gain stage 603. The output from the gain stage, either alone or together with other gain stage outputs, is the second feedback signal at 544. Additional series coupled circuits each comprising a delay stage with an input coupled to 511 and output coupled to a gain stage, e.g., delay stage 605 coupled from 511 to gain stage 607 can be utilized. As shown by the dotted line 609, this structure can be repeated as needed with the outputs from all gain stages combined via summers or combiners 611, 613, etc. to provide the second feedback signal at 544. In view of the approaches shown in FIG. 5 and in FIG. 6 it will be evident that many forms of networks can be utilized as well as any order between the gain stages and the delay stages, provided appropriate steps are taken to insure the needed gain and delay is applied to the signal at the sequencer output.

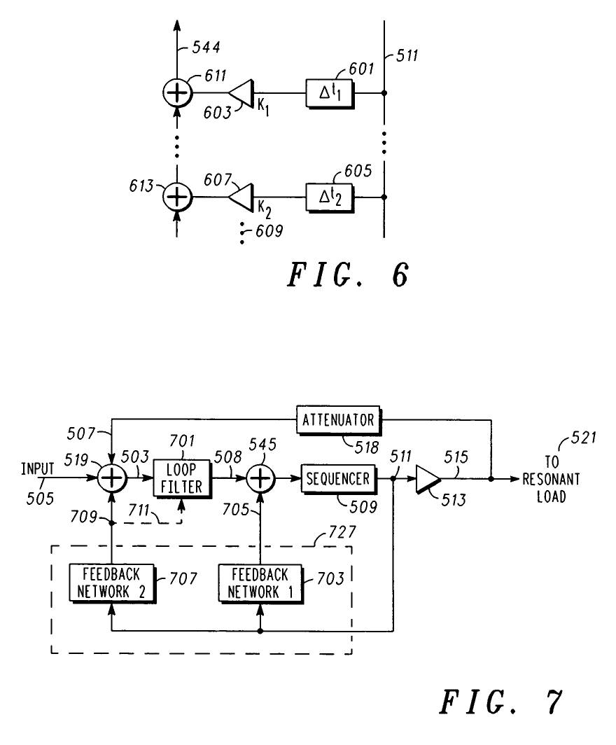

Referring to FIG. 7 a representative block diagram of a generalized second feedback system suitable for use in one or more radio frequency power amplifiers in accordance with various exemplary embodiments will be discussed and described. The radio frequency power amplifier of FIG. 7 comprises many of the same elements as FIG. 5 including input signal 505 and a feedback control system further comprising a loop filter 701 and a sequencer 509 with an output of the loop filter 508 coupled via combiner 545 to an input of the sequencer 509. The loop filter is coupled to a signal corresponding to the input signal and the first feedback signal, e.g., sum of these signals from summer 519, and the feedback signal corresponds to the output signal 515 as reduced by attenuator 518. The output signal 515 is provided by a switching stage 513 and this signal is coupled to the load 521. The sequencer drives the switching stage.

Further shown is a second feedback system that provides one or more second feedback signals with one provided by feedback network 703 which is coupled to combiner 545 and thus to the sequencer input and another provided by feedback network 707 which is coupled at 709 to summer 519 and thus the input to the loop filter 701 or at 711 to the loop filter 701. The second feedback system 727, specifically one or more of feedback networks 703, 707 includes one or more of a discrete time portion, a continuous time portion, and a memory portion (portion where present output is affected at least in part by a previous input). Note that only one of the feedback networks needs to be present in some embodiments, e.g., feedback network 703 in various of the above discussed embodiments where the feedback system is coupled to the sequencer input. In other embodiments only feedback network 707 is present and serves similar purposes provided appropriate responses are chosen for the network, e.g., different delays and gains. When the feedback network is coupled to the loop filter it can be done via a transconductor coupled to an internal filter state (presuming the loop filter is implemented using gmC elements), thus varying the output of the loop filter in accordance with the second feedback signal.

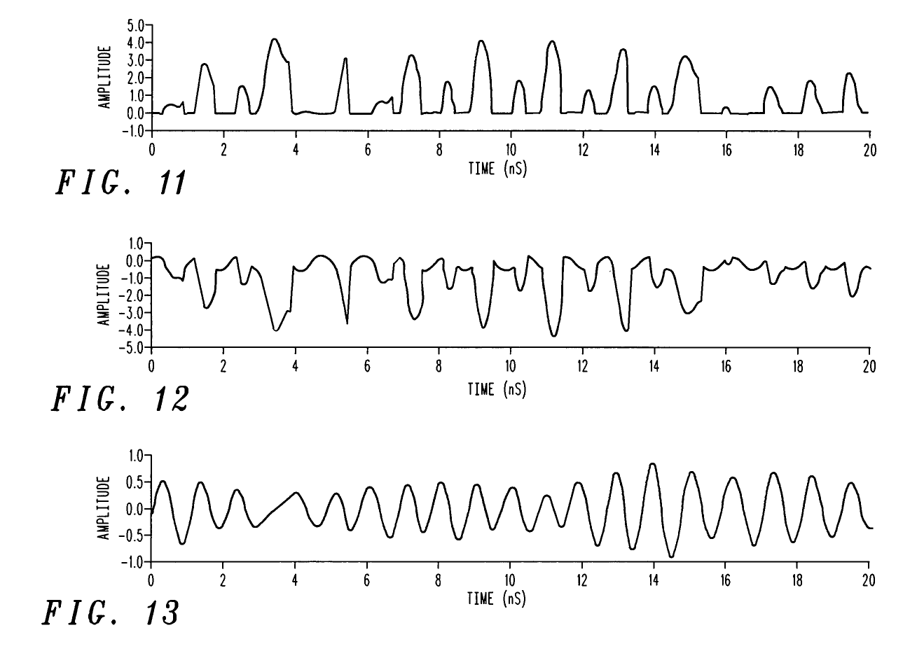

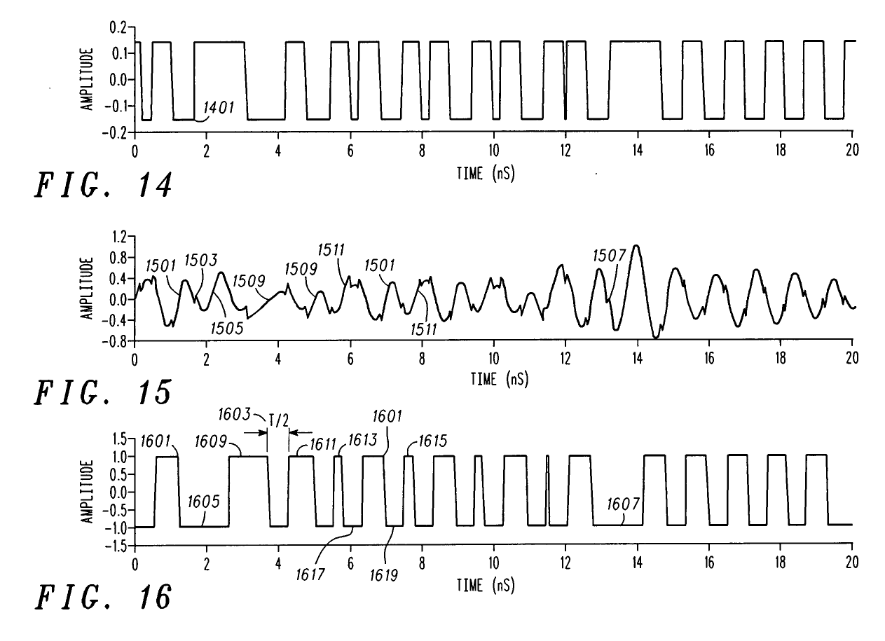

Referring to FIG. 8 through FIG. 19, various representative waveforms captured from an experimental simulation of a radio frequency power amplifier in accordance with the embodiment depicted in FIG. 2 (less the parallel network 229) will be discussed and described. Note that the input signal in FIG. 2 is centered at the carrier frequency, i.e., a frequency of 875 MHz. FIG. 8 shows the input signal 205 over a one micro second (1 μs) time period. Note that the input signal envelope demonstrates that the input signal includes amplitude (AM) modulation where the envelope varies from approx 300 millivolts to near zero in some instances with an approximately 6 dB peak to average ratio. Note also that the input signal includes phase modulation, i.e., PM, that is not particularly evident. The input signal is similar to that found for example, in code division multiple access (CDMA) systems, such as wideband CDMA systems. FIG. 9 shows the same input signal over the first 200 nano seconds (200 nsec) where again the AM modulation is clearly evident. FIG. 10 shows a 20 nsec portion of the input signal where the carrier signal (approximately 875 MHz) is evident, however given the time scale and the particular portion of the input signal little if any AM or PM modulation is evident. FIG. 11-FIG. 18 show the waveforms observed at various points in the radio frequency amplifier for the same 20 ns time period.

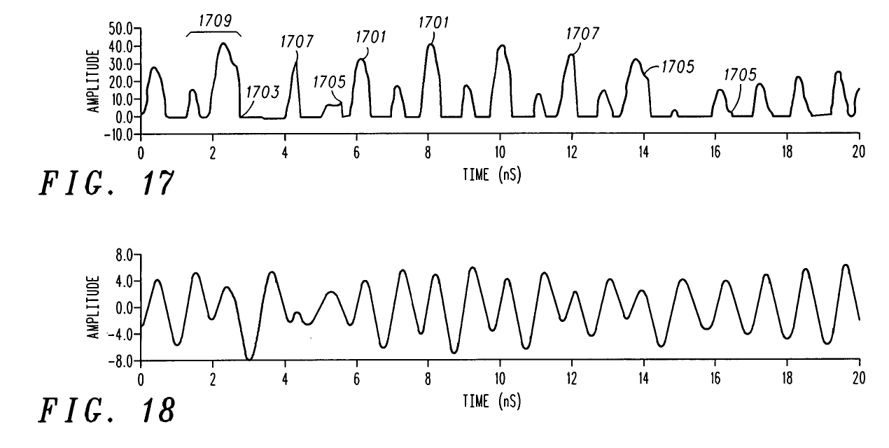

FIG. 11 shows the feedback signal 207 over the 20 ns time period. This feedback signal corresponds to the output signal at 215 with a delay equal to one cycle at the radio frequency carrier, i.e. at 875 MHz—approx. 1.14 ns (compare to FIG. 17). Each of the pulses arises or occurs when the sequencer 209 enters the OFF state and the switching stage 213 becomes an open circuit. The feed inductor 217, capacitor 231 (some or all of which may be parasitic capacitance of switching stage 213) and resonant circuit 221 as well as the charge states (conditions when time OFF state starts) for each of the elements determine the particular form of the respective pulses. The pulses end when the sequencer enters the ON state and the switching device becomes a short circuit. The input signal and the feedback signal are combined in the summer 219 and yield the waveform of FIG. 12. Note that the waveform of FIG. 12 is essentially the difference between the input and the feedback signals. This is the waveform that is input to the loop filter at input 203.

The loop filter is typically a bandpass filter in the FIG. 2 power amplifier embodiment as earlier noted and as will be further described below. The output of the loop filter is shown in FIG. 13. The waveform of FIG. 13 is coupled to the combiner 216 at input 208 along with the second feedback signal, shown in FIG. 14, from the second feedback system 212. Note that the second feedback system used in these simulations included a single delay stage with slightly less than T/2 delay (at 875 MHz approx. 0.57 ns where the delay used was approx. 0.5 ns) and a single gain stage with an approximate gain setting of −0.15. These signals are added together to provide the combiner output signal, i.e., input signal for the sequencer 209 shown in FIG. 15. The discontinuities observed in the FIG. 15 waveform is the result of adding the second feedback signal (essentially a two state signal ignoring non-zero switching times) to the filter output signal.

The sequencer output signal at 211 is shown in FIG. 16. The sequencer output signal is a quantized signal that in this embodiment, ignoring small non-zero switching times, includes an OFF state (sequencer output signal is low at −1 volts and switching stage 213 is essentially an open circuit or OFF) and additionally an ON state (sequencer output signal is high at 1 volts and switching stage is essentially a short circuit or ON), with each state occurring multiple times. Note that rising edges (zero crossings) 1501 in FIG. 15 result in the sequencer entering the OFF state 1601 (two occurrences specifically labeled 1601). The OFF state in the particular sequencer embodiment (see 309 in FIG. 3) with the output signal shown in FIG. 16 lasts for a minimum time period of approximately or slightly less than T/2 1603 (i.e., a half-cycle of the carrier frequency—at 875 MHz is approx 0.57 ns, thus use a minimum time period of approx. 0.5 ns). Thus the sequencer output includes an OFF state that begins at a variable time that corresponds to the combiner output in FIG. 15 (filter output as modified in accordance with the second feedback signal) or corresponds to the output signal (see FIG. 17 as further described below).

Note that rising edges, e.g., 1503, 1505, etc., at the output of the combiner 216 (sequencer input FIG. 14) that occur while the sequencer is in the OFF state (e.g., 1605) retrigger the sequencer and result in extending the duration of the OFF state. This is the result of using the optional pulse generator 345 or similar functionality (e.g., re-triggerable one shot). The OFF state can be extended by the length of time between the two or more (in this instance 3, i.e., 1501, 1503, 1505) successive rising edges. Similar circumstances in the sequencer input result in the extended OFF state 1607. If the re-triggering function was not used there would be no impact from a rising edge during an OFF state or period. It is also noted that the frequency of occurrence of the OFF state varies from one time period or frame to another as readily observed from FIG. 16 and also varies from the frequency of the input signal (see FIG. 10).

By observation and comparison of FIG. 14 and FIG. 16, it is evident that the amplitude of the second feedback signal in FIG. 14 results from applying a gain factor of approximately −0.15 to the sequencer output and a delay of approximately 0.5 ns via the second feedback system, i.e., the amplitude of the second feedback signal is approximately 15% of the amplitude of the sequencer output and the signal has been inverted (minus sign −180 degree phase shift) and delayed by approx 0.5 ns (compare 1601 to 1401). Furthermore the second feedback signal has resulted in the sequencer being retriggered on two occasions (see rising edge crossing zero due to discontinuity at 1505 and 1507.

Essentially the second feedback signal in FIG. 14 when added to the filter output signal in FIG. 13 either advances or retards the time when the rising edge of the combiner output or sequencer input crosses zero and thus the variable time when the sequencer enters or assumes the OFF state. For example 1509 shows two of many instances where the zero crossing has been delayed or retarded from when it would have occurred if the second feedback signal was not present. Two instances of many where the zero crossings have been advanced relative to when they would have occurred without the second feedback signal are shown at 1511. Thus the second feedback system and signal is provided and deployed to cause the OFF state to begin earlier with the second feedback signal than without the second feedback signal in some instances. Furthermore, the second feedback system and signal is provided and deployed to cause the OFF state to begin later with the second feedback signal than without the second feedback signal in various instances.

Additionally as observed, e.g., in the 3-5 ns and again between 10 and 12 ns range, in FIG. 15, the second feedback signal has a larger relative impact on the sequencer input signal and thus aforementioned variable time when the filter output signal is smaller than when, e.g., in the 13-15 ns range, the filter output signal is larger (discontinuities are larger portion of the entire sequencer input signal). Thus the second feedback signal is provided and deployed to affect the variable time when the sequencer is triggered or enters an OFF state to a greater extent when the filtered signal is smaller than when the filtered signal is larger.

Also it will be evident that the second feedback system and signal are deployed and operate to over steer the sequencer output in the sense that long (using a T/2 reference length) duration ON states are longer due to the second feedback signal and correspondingly the variable time associated with the beginning of an OFF state is delayed due to the second feedback signal than either would have been without the second feedback signal. Similarly the second feedback system and signal further operates to over steer the sequencer output in the sense that short (using the T/2 reference length) duration ON states are shorter and correspondingly the variable time associated with the beginning of an OFF state is advanced due to the second feedback signal than either would have been without the second feedback signal.

For example the ON state 1609 would have been longer than T/2 when a zero crossing due to the rising edge at 1509 is projected without the effects of the second feedback signal and is even longer (zero crossing delayed) with the effects of the second feedback signal. Similar observations can be made with reference to ON state 1611. In contrast a short ON state 1613, 1615 is even shorter due to the zero crossing being advanced (see 1511) due to the second feedback signal. In essence the second feedback signal magnifies or operates to increase a difference (magnitude) between the reference duration of the ON state and an actual duration. This may be viewed as the second feedback signal increasing the second moment, variance, or variation in the duration of the ON states as well as the variable time when the OFF state begins.

FIG. 17 shows the output signal at 215, i.e., at the drain of the switching stage 213, that results given the sequencer output signal of FIG. 16, etc. It will be observed that pulses, e.g., 1701, are typically generated whenever the sequencer is in a corresponding OFF state, e.g., 1617, 1619 and others and these pulses are reaching amplitudes over 40 volts. Pulses end or are terminated whenever the sequencer starts or initiates an ON state, e.g., 1703 (see 1609), and the switching stage becomes a short circuit, although some end long before that (see pulse at 15 ns). The ON state is normally initiated at a starting time that corresponds to a voltage minimum in the output signal. For example, pulses 1705 are terminated near a voltage minimum and for these pulses as readily observed near or shortly before/after the voltage minimum. As another observation, pulses 1701 and others are terminated near a voltage minimum and for these pulses near zero volts across the switching stage. In some instances, pulses are abruptly terminated, e.g., 1707, however the majority of the pulses are terminated at or near a voltage minimum and on average near 0 volts across the switching stage. When the sequencer output and thus switching device is in an OFF state for a long time period, e.g., 1605, the output signal can include multiple pulses 1709 (indicating ringing in the resonant load). A comparison of the feedback signal in FIG. 11 with the output signal in FIG. 17 shows a factor of 10 attenuation in the amplitude of the feedback signal as well as a delay of approximately one cycle at the carrier frequency.

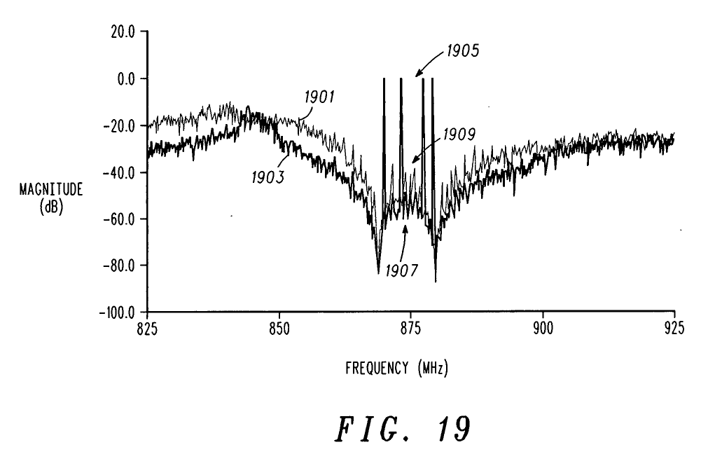

The load voltage after some filtering and thus removal of out of band noise and harmonic content is shown in FIG. 18. FIG. 18 shows a waveform of the voltage across the load 223 that results from the output waveform of FIG. 17 with peak amplitudes approaching 8 or so volts. This waveform includes significant amounts of essentially switching or quantization noise as well as 2^{nd} and higher order harmonics that may be readily removed with an appropriate harmonic filter, e.g. a band pass radio frequency filter, before applying the resultant signal to an antenna or cable or the like.

Those familiar with class F or class E power amplifiers will note that normally these stages are designed to and typically will switch at near zero volts (pulses 1701) across the switching stage, thereby minimizing power dissipation in the switching stage. However class F or class E in order to consistently switch near zero volts have to provide near a maximum output power given the voltage supply, V_{DD}, for the switching stage and other design values, i.e. class E and class F are not normally capable of AM modulation or PM modulation of more than very small deviations without degrading either efficiency or linearity and typically both. In the embodiment simulated above, the class E amplifier is driven to replicate AM and PM modulation on the input signal, e.g. provide an output signal that is often less than the maximum output given a particular voltage supply, V_{DD} 220, as well as replicate PM modulation. One of the artifacts of reproducing AM and PM modulation using the power amplifier of FIG. 2 is occasionally closing the switching stage when the output signal is not near zero volts, e.g., pulses 1707. In these instances, power will be dissipated by the switching stage at least during the switching time when both voltage and current are non-zero.

However this dissipation can be minimized by turning the switching stage ON when the output signal voltage is near a minimum voltage as depicted by many of the pulses in FIG. 17 and particularly pulses such as pulses 1701 and the like. Note that other 20 nsec segments of waveforms such as those of FIG. 10 through FIG. 18 may show many of the output pulses being terminated at near zero voltage or many of the output pulses being terminated earlier/later than the minimum output voltage. If the pulses are terminated near a minimum voltage the resultant efficiency will be close to the best efficiency available from the class F or class E power amplifier driven to replicate complex modulation including AM and PM modulation using the feedback control systems variously described above.

For example, if the efficiency does not suffer more than 15% as a result of the specific time (before or after minimum voltage) that the output pulses are terminated (switching stage enters ON state), the starting time of the second or ON state may be viewed as near to or corresponding to a voltage minimum for the output signal. Note also that the switching stage when driven by the sequencer in the feedback control system may turn the switching device ON at a point that is not close to a voltage minimum for a particular pulse in order to provide near optimum turn on times for many successive pulses. In essence, if on average the pulses are being terminated near a voltage minimum, efficiency will be near an optimum value given that AM and PM modulation is being imposed on a carrier signal by a class E or class F or the like power amplifier.

FIG. 19 shows a close in frequency spectrum of the waveform of FIG. 18 which results when a second feedback system (one delay and one gain stage) as discussed and described above is used with the resultant spectra 1903 depicted as a darker line. This spectrum is centered at a frequency near 875 MHz and shows desired sidebands 1905 clearly indicative of AM and PM modulation components as well as the undesirable quantization noise, etc. Note that in band, the quantization noise, etc. is down by more than 50 dB in the 10 MHz bandwidth centered at the carrier frequency. This spectra is compared to another spectra of a corresponding waveform where a second feedback system is not utilized with this comparison spectra 1901 depicted with a lighter line. By observation significant improvement in in-band (near carrier) noise or undesirable energy components 1909 for spectra 1901 as compared to 1907 for spectra 1903 have been realized with the use of the second feedback system. Quantitative measurements with the second feedback network showed a total signal to noise level over the 10 MHz band to be approximately 45 dB whereas without the second feedback network the total signal to noise was 36 dB. Efficiency with the second feedback network improved to 24% from approximately 16% without the second feedback network with an output signal power of approximately 6 watts.

Generally the particular implementation of a sequencer will depend on a multitude of factors including the switching stage, feed inductor, resonant circuit(s), feedback path and loop filter gain and phase parameters. The sequencer should be implemented such that given all of the other parameters the sequencer output is provided in the proper state and at the proper time and for the proper time duration to cause the switching stage to turn ON or OFF so as to generate an output signal that when fed back and combined with the input signal will drive the output of the loop filter toward zero. This may be referred to as generating a counter phase or opposing phase loop filter output. Similarly, the particular implementation of the second feedback system will depend on other factors and elements in the radio frequency power amplifier and feedback control system and specifically various delays therein. Generally the second feedback system will have less inherent loop delay than the feedback control system in combination with the switching stage. This fact or observation can be used to “predict” what will occur with the switching stage and the like and compensate for undesirable aspects thereof. For example, in the simulations discussed above the second feedback signal resulting from a given sequencer output arrives at or begins to affect the input to the sequencer at least T/2 seconds before the output signal and resultant feedback signal begins to have an impact on the sequencer input.

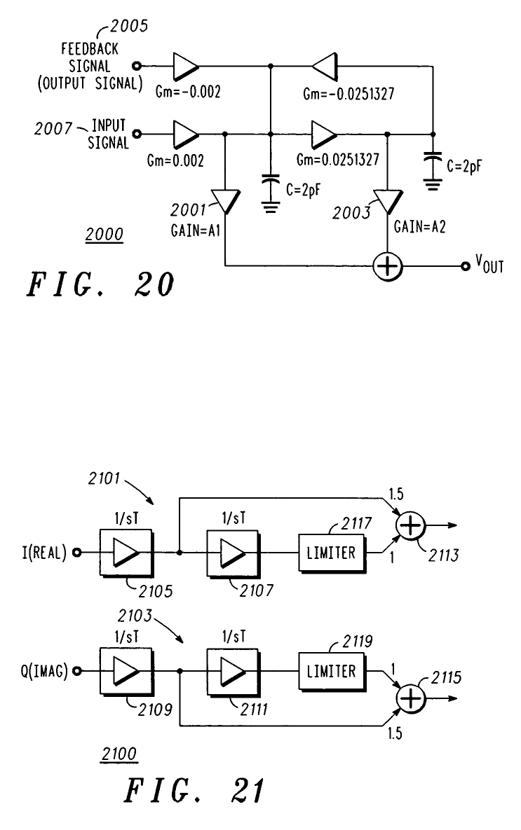

Referring to FIG. 20, a block diagram of a loop filter suitable for use in one or more embodiments of a radio frequency power amplifier will be discussed and described. The loop filter of FIG. 20 is a known transconductance capacitor (gm-C) filter that is shown in a generalized form, i.e., the filter can be a low pass or band pass filter depending on the selection for gains A1, A2 2001, 2003. For example, if A1 is set to unity (1) and A2 to zero (0) a band pass filter results. As shown the filter has two inputs, namely the feedback signal 2005 and input signal 2007 (analogous, e.g., to output signal at 105, 215, 315 and input signal 107, 205, 305, etc). Note that the filter of FIG. 20 is also acting as the summer in FIG. 2-FIG. 5, etc.

The filter of FIG. 20 when implemented as a band pass filter with the values of gm and C shown, A1=1, and A2=0, has a center frequency of 2 GHz and a theoretically infinite Q (i.e., not limited by an impedance at the output of the gm blocks). The roll off characteristic on either side of the center frequency is 20 dB per decade. Note that this filter may be frequency scaled to any value of interest (carrier frequency or intermediate frequency) according to known techniques, e.g. increasing the capacitor values will lower the center frequency. The values of A1 and A2 can be selected/adjusted to tune and optimize the system performance of the radio frequency power amplifier and thus account for circuit parasitics and various other non-idealities. Generally it has been found that adjusting these values can improve signal to noise performance with limited impact on efficiency. Various classes of bandpass filters can be employed to realize the loop filter when a band pass version is needed. A fourth order filter may be used in embodiments of a radio frequency power amplifier with a non-DC centered input signal, where the filter has a transfer function of the form:

$$L ( s ) = \frac{( - 0.496 {s}^{s} - 0.0609 {s}^{s} - 4.896 s + 1.615 )}{{( {s}^{2} + {π}^{2} )}^{2}}$$

Note that this filter has a resonant or center frequency of 0.5 Hz but may be frequency scaled in accordance with known techniques. While this filter is known to work appropriately, there are various other appropriate filter transfer functions.

When the radio frequency power amplifier uses frequency translation and down converts the output signal to a base band frequency corresponding to an input signal centered at DC a low pass filter will normally be used. This may be comprised of single integrator stages, one for a real (I) path and one for an imaginary (O) path. Higher order filters may also be used, such as the filter depicted in FIG. 21. Recalling the discussion of FIG. 4, the loop filter needs to filter a complex signal and thus includes a real path 2101 and an imaginary path 2103. Here the single integrators noted above are replaced by a second order function using, for example, two integrators 2105, 2107 or 2109, 2111 plus a summer 2113 or 2115. Each of the I and Q filters has a transfer function of the form (1.5sT+1)/(sT)² as depicted. Note that the output of the second integrator is applied to a limiter 2117, 2119. This is a means for limiting the maximum contribution of the “momentum” term 1/(sT)². This term is one mechanism that may contribute to instability. Clipping this term does not ordinarily limit the intended operation of the filter when, for example, clipping levels are set at 4 standard deviations. Other stabilization techniques may be applied such as clipping other integrator outputs or nulling integrator outputs if the overall output from the filter is too large or does not change sign for too many samples. Note that the output of the summers 2113, 2115 is used to drive the complex mixer 407 in FIG. 4.

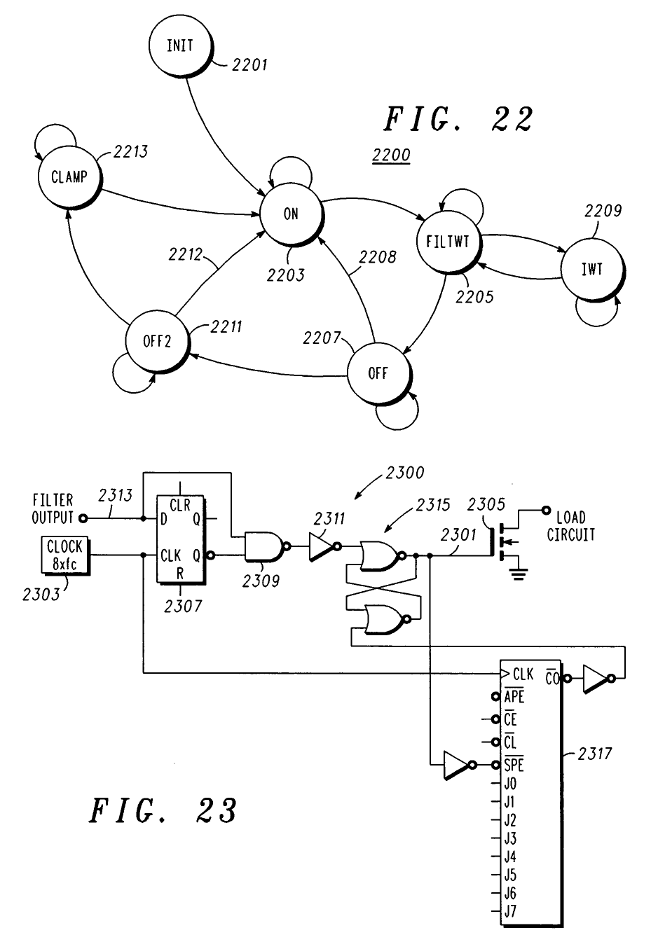

Referring to FIG. 22, an exemplary state machine that represents another embodiment of a sequencer that may be employed in FIG. 1 through FIG. 4, etc. will be discussed and described. “Init” 2201 is the start state. From that state, the output switch or switching stage is immediately turned “On” 2203. The machine starts in the “On” state so the choke feed inductor that is supplying the output transistor can charge up. The machine stays in the “On” state in some embodiments for at least some minimum time “on Min” in order to avoid small glitches and thus avoid possible issues with the life expectancy of the switching stage and various drivers. In this embodiment the machine stays in the “On” state until a threshold level of current, e.g. “iTrigger”, is flowing through the switch. This makes sure that the pulse in the output signal is going to go positive rather than negative when the switch opens. Note that the catch or snub diode in the various embodiments also enforces this. The state machine also remains in the “On” state until the loop filter output is negative. This is a way of making the next transition be positive-edge-triggered.

Given that a sufficient number of these preconditions are satisfied, the state machine waits for the loop filter plus second feedback signal or system to say go, i.e., waits for an initiating signal from the loop filter, etc.—“filtwt” 2205 (filter wait). If the loop filter with second feedback system says “go” (i.e. makes a transition to a positive value) while we're still seeing positive switch current (meaning that the pulse will go positive if the switching stage is opened), then open the switching stage, i.e., go to state “Off” 2207. Note that once the switching stage is turned off actual output power starts to be generated, i.e. applied to the resonant circuit and thus load. Otherwise if the switch current goes negative before the filter and second feedback system says “go”, go to state “Iwt” 2209 (“current wait”). “Iwt” just waits for the switch current and loop-filter current phase to be proper and then goes back to waiting on the filter 2205. This means that filter output is negative and thus a positive transition is expected and further means the switch current is positive so when opened a positive pulse is generated.

Given that the state machine is in the “Off” state 2207; if a maximum time “offMax” is exceeded in this state, go back 2208 to state “On” 2203. This was originally proposed as a failsafe operating mode. This has been implemented as the one-shot that resets the D flip flop after a certain period of time. Note that when this transition happens, we may be wasting power when the switch is not being turned on at a safe time (i.e. when drain voltage is zero). Alternatively if the derivative of drain or output voltage goes negative, then the voltage of the output signal is on the way back down and the machine goes to state “Off2” 2211.

In state “Off2”, the drain or output signal voltage is on the way down; and either it will cross zero or it will turn around, i.e., start increasing (see FIG. 17). If the output signal voltage turns around and starts going positive, then turn 2212 the switching stage “On” 2203. Note that from an efficiency perspective this may not be a good thing to do, but similar to transition 2208 it is better than letting the output signal voltage continue to increase. Alternatively if the output signal voltage crosses zero, go to state “clamp” 2213, which effectively turns the switching stage on. This can be implemented as a catch diode as noted in one or more embodiments. Stay in the “clamp” state 2213 until the switching stage current goes positive, at which point the state machine goes to state “On” 2203 (transistor switching stage closed) to hold the voltage down. Note that in the above discussed embodiments or circuit implementations it's fine to have the transistor “On” even while the diode is “clamping”.

Referring to FIG. 23, an alternative embodiment of a sequencer 2300 that provides a sequencer output at 2301 asynchronously when synchronously clocked, e.g., from a fixed clock 2303. The clock 2303 is shown as toggling for example, at 8 times the carrier frequency for an output signal from the corresponding radio frequency power amplifier. The sequencer 2300 may be arranged to generate a plurality of output signals or sequencer outputs with each one having a different and corresponding time profile (e.g., starting and ending time for an OFF state). The sequencer output is used to drive a switching stage 2305, such as the switching stage in one of FIG. 1 through FIG. 4 or the like.

The fixed clock running at 8 times the carrier frequency is a compromise. Higher rates would be better for power amplifier performance, and the sequencer would work at a somewhat lower rate, however 8× is a reasonable compromise between the difficulties of high speeds and the poor performance of coarser sampling. The D flip flop 2307, NAND gate 2309 & inverter 2311 are a zero-crossing detector. The input 2313 from “filter output” is assumed to be appropriately level shifted so that an analogue zero corresponds to the trigger point of logic inputs. The NAND gate is looking for situations where the input used to be 0 (so Q bar is “1”) but is now “1”. The inverter 2311 converts that into a “1”, i.e., positive logic.

The cross-coupled NOR gates 2315 functionally operate as an RS flip-flop. A “1” out of the zero crossing detector (inverter 2311) forces its upper output, i.e. sequencer output at 2301 to “0”, i.e. the OFF state, which results in a) turning OFF the RF switching stage 2305 and thus causing a pulse to start and b) starts the one-shot counting. The one-shot 2317 is a binary down counter that can be preloaded, e.g. with 011 (J0, J1). When the RF switch is “ON”, this counter is preloaded to “011”, i.e. 3 counts plus one delay at a rate of 8× carrier, hence one half-cycle of the carrier. During this “switch ON”-state the carry-out (negative logic, hence inverted) is zero, keeping the RS flip flop 2315 ready to be triggered by the zero-crossing detector. When the RS flip flop 2315 is triggered and the RF switch turns OFF, the counter starts to count down towards zero. When it reaches zero, the carry-out resets the RS flip flop 2315 and the switch and system return to the “switch-ON” state awaiting another trigger.

Note that advantageously the feedback control system 113 of FIG. 1 may be implemented in the discrete time domain using digital signal processing techniques and appropriate continuous to digital and digital to continuous conversion processes at the relevant interfaces.

Other embodiments of the sequencer (not depicted) can select from a plurality of sequencer outputs using interpolation. For example by noting the filter output and possible earlier or intermediate results from the filter (e.g., prior to last integrator) at a clock time or at sequential clock times (the clock having a frequency similar to the carrier frequency), an estimate of the filter output in the recent past and near future can be made and thus one of the plurality of pulses can be selected, e.g. from a look up table, to provide the OFF state or ON state with an appropriate time profile, i.e. a starting time and ending time. The plurality of pulses would be selected such that each varied from the other by a few degrees and thus the appropriate resolution over a carrier period required to control the switching stage would be provided.

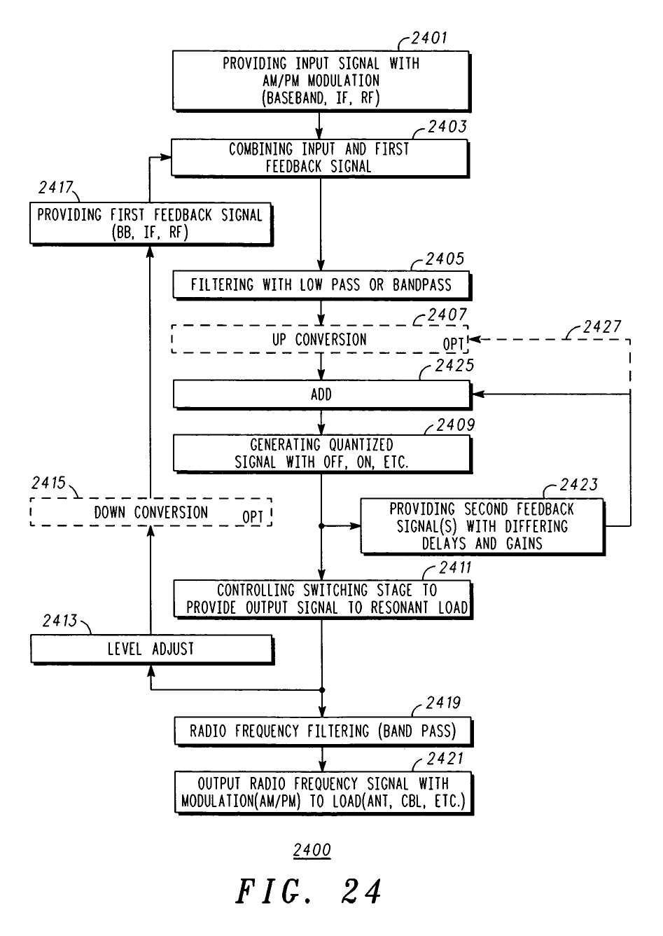

Referring to FIG. 24, a flow chart of a method of providing a radio frequency signal with complex modulation according to one or more embodiments will be discussed and described. It is noted that the method of FIG. 24 may be implemented in one or more of the embodiments discussed above or in alternative radio frequency amplifiers with similar functionality. Given that many of the inventive concepts and principles embodied in the method of FIG. 24 have been discussed and described above with reference to various apparatus, the present discussion will be in the nature of an overview and summary.

The method 2400 is a method of providing a radio frequency signal with complex modulation (AM, PM, or AM & PM), e.g. an amplified version of an input signal with the same modulation, and begins at 2401 with providing an input signal including complex modulation (AM/PM modulation) at base band (BB), an intermediate frequency (IF) or radio frequency (RF). At 2403 as shown combining the input signal with a first feedback signal at the same frequency is performed. Next the method includes filtering the combination of the input signal and the feedback signal 2405 to provide a filtered signal, where the filtering is done with a low pass filter if the combination signal is a base band signal and ordinarily with a bandpass filter if the signal is centered at an IF or RF (carrier) frequency. As noted earlier if the input signal is at base band or at IF typically, it and the feedback signal will be in complex form and the combining process and filtering processes will handle complex signals.

Next the optional process 2407 can be used to up convert or frequency translate the filtered signal when that signal is at base band. Then 2425 shows adding a second feedback signal discussed below to the filtered signal. Then 2409 shows generating, responsive to the filtered signal plus second feedback signal, a quantized signal having an OFF state, ON state, etc. where the OFF state begins at a variable time, e.g., that corresponds to the filtered signal plus second feedback signal. Thus the generating the quantized signal can be directly responsive to the second feedback signal. Then 2423 shows providing, responsive to the quantized signal, a second feedback signal having, e.g. appropriate gains and delays, and deployed to affect the generating the quantized signal. For example, the second feedback signal can as depicted be added to the filtered signal at 2425 and thus affect or modify the filtered signal with the resultant signal used to trigger the generating the quantized signal. In alternative embodiments the second feedback signal can be coupled at 2427 to the up conversion process and used, e.g., to vary a phase shift of a local oscillator, and thus a phase of the filtered signal as up converted or frequency translated with the resultant signal used to trigger generating the quantized signal.

The providing the second feedback signal in some embodiments comprises forming one or more delayed and weighted versions of the quantized signal and combining the one or more delayed and weighted versions of the quantized signal to provide the second feedback signal. The forming and the combining in some embodiments comprises forming and combining continuously and asynchronously at least a portion of the one or more delayed and weighted versions of the quantized signal. As noted above, the providing the second feedback signal can include providing one or more second feedback signals using one or more of a discrete time process, a continuous time process, and a process with memory. In various embodiments, the second feedback signal is deployed to cause the OFF state to begin either earlier or later with the second feedback signal than without the second feedback signal. Furthermore, the second feedback signal as deployed can affect the variable time to a greater extent when the filtered signal (input to ADD process 2425) is smaller than when the filtered signal is larger. Additionally in some embodiments the generating the quantized signal further comprises generating a quantized signal having an ON state with a duration and the second feedback signal is deployed to increase a magnitude of a difference between the duration of the ON state and a reference duration, e.g., T/2, as noted above.

Controlling a radio frequency switching stage with the quantized signal to provide an output signal to a resonant load occurs at 2411. The output signal is level adjusted 2413 and optionally down converted in a base band system 2415 and used to provide the first feedback signal at BB, IF, or RF 2417 to the combining process at 2403. Note that the output signal comprises an amplified version of the input signal with the complex modulation, i.e., the radio frequency signal with the complex modulation. The first feedback signal corresponds to the output signal as level adjusted and in some instances frequency converted. The output signal is filtered 2419 with typically a band pass filter and then output 2421 to a load (antenna, cable, etc.) as a radio frequency signal with modulation.

Note that generating the quantized signal can include generating a quantized signal having a second state, where the second state starts at a time near a voltage minimum for the output signal. The quantized signal can further comprise an OFF state having a minimum time duration and an ON state having a variable time duration.

The processes, apparatus, and systems, discussed above, and the inventive principles thereof are intended to and can alleviate problems caused by prior art radio frequency power amplifiers. Using these principles of defining/providing a radio frequency switching stage with a resonant load and managing or controlling switching times using a feedback control loop or system in addition to a second feedback system may simplify faithfully reproducing complex modulation with such switching stages and also allow for reasonable amplifier efficiencies. Using the above noted principles and concepts allows the use of less capable switching stages (lower costs) as well as facilitates the use of alternative switching stages from alternative manufacturers of such devices with limited if any change to the radio frequency power amplifier. This is expected to reduce “costs” (economic, size, weight, life expectancy, power consumption, etc.) associated with radio frequency power amplifiers in present and future communication systems and thus facilitate connectivity for users of such systems.

One of the principles used is to control switching times given the switching stage, accompanying resonant load, and specifics of a radio frequency signal with complex modulation, such that on average the switching occurs at or near a voltage minimum across the switching stage. The use of the second feedback system and signal as variously noted above allows for longer loop delays in the radio frequency power amplifier while improving or at least maintaining satisfactory signal to noise (linearity) and efficiency and additionally has provided a surprising improvement in signal to noise and efficiency even without loop delay. This dramatically reduces power dissipation in and thus increases efficiency of the resultant radio frequency power amplifier. Various embodiments of methods, systems, and apparatus for effecting control of switching stages so as to facilitate and provide for faithful complex modulation of resultant radio frequency power amplifier output signals in an efficient manner have been discussed and described. It is expected that these embodiments or others in accordance with the present invention will have application to many communication networks. Using the inventive principles and concepts disclosed herein advantageously facilitates communications using linear complex modulation which will be beneficial to users and providers a like.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A radio frequency power amplifier comprising:
a feedback control system coupled to a signal corresponding to an input signal and a first feedback signal and configured to provide a sequencer output;
a second feedback system responsive to the sequencer output and configured to provide a second feedback signal that is coupled to the feedback control system; where the sequencer output has at least one state with a starting time that is determined by the feedback control system; and
a radio frequency switching stage driven by the sequencer output and configured to provide an output signal, the first feedback signal corresponding to the output signal.

2. The radio frequency power amplifier of claim 1 wherein the feedback control system is responsive to the input signal, the first feedback signal, and the second feedback signal to provide the sequencer output.

3. The radio frequency power amplifier of claim 1 wherein the radio frequency switching stage further comprises a radio frequency switching stage configured to drive a resonant load and configured to switch ON responsive to the sequencer output so that over a multitude of switch ON events an average voltage imposed on the radio frequency switching stage at the switch ON event is less than ½ of a specified breakdown voltage associated with the radio frequency switching stage.

4. The radio frequency power amplifier of claim 1 wherein the radio frequency switching stage as driven by the sequencer output is further configured to provide an output signal that includes an amplified replica of the input signal over an input signal bandwidth, where the input signal includes at least one of amplitude modulation and phase modulation while the radio frequency switching stage is powered from a constant voltage power supply.

5. The radio frequency power amplifier of claim 1 wherein the feedback control system comprises a sequencer configured to provide the sequencer output and the second feedback signal is coupled to an input of the sequencer.

6. The radio frequency power amplifier of claim 5 wherein the second feedback system comprises one or more delay stages with outputs coupled to a corresponding one or more gain stages with each of the gain stages having an output, where the second feedback signal corresponds to a combination of the signal at the output of each of the one or more gain stages.

7. The radio frequency amplifier of claim 6 wherein the one or more delay stages is a tapped delay line with each tap coupled to a different one of the one or more gain stages.

8. The radio frequency power amplifier of claim 6 wherein at least one of the one or more delay stages and at least one of the corresponding one or more gain stages is operating asynchronously.

9. The radio frequency power amplifier of claim 1 wherein the feedback control system further comprises a loop filter and a sequencer with an output of the loop filter coupled to an input of the sequencer, the loop filter coupled to the signal corresponding to the input signal and the first feedback signal and wherein the second feedback signal is coupled to at least one of the loop filter and the input of the sequencer.

10. The radio frequency power amplifier of claim 9 wherein the second feedback system comprises one or more feedback networks including one or more of a discrete time portion, a continuous time portion, and a memory portion.

11. The radio frequency power amplifier of claim 9 wherein the second feedback system comprises a feedback network coupled from the sequencer output to the sequencer input.

12. The radio frequency power amplifier of claim 9 where in the second feedback system comprises a feedback network coupled from the sequencer output to the loop filter.

13. The radio frequency power amplifier of claim 1 wherein the feedback control system comprises a loop filter with a filter output coupled to an input of a sequencer, the sequencer configured to provide the sequencer output, where the sequencer output has an OFF state with a starting time that corresponds to the filter output as modified in accordance with the second feedback signal and an ON state that has a starting time corresponding to a voltage minimum for the output signal.

14. The radio frequency power amplifier of claim 13 wherein the sequencer is further configured to provide the sequencer output where the OFF state has a minimum time duration and the ON state has a variable time duration.

15. The radio frequency power amplifier of claim 14 wherein the sequencer is further configured to provide the sequencer output with an OFF state having a predetermined time duration.

16. The radio frequency power amplifier of claim 14 wherein the sequencer is further configured to provide the sequencer output in the OFF state when the filter output as modified in accordance with the second feedback signal corresponds to a predetermined state and to provide the sequencer output in the ON state after a time lapse that corresponds to the minimum time duration starting at the last occurrence of the predetermined state.

17. The radio frequency power amplifier of claim 13 wherein the sequencer is configured to provide the sequencer output asynchronously.

18. The radio frequency power amplifier of claim 13 wherein the sequencer is configured to provide the sequencer output asynchronously when driven by a fixed clock, the sequencer output generated with one of a plurality of time profiles.

19. The radio frequency power amplifier of claim 13 wherein the sequencer further comprises a flip flop clocked from the filter output as modified in accordance with the second feedback signal and the sequencer is configured to provide the sequencer output in the OFF state when triggered by the filter output as modified in accordance with the second feedback signal and in an ON state after a time lapse determined by a Reset signal for the flip flop.

20. The radio frequency power amplifier of claim 13 further comprising a mixer arrangement configured to:
provide the feedback signal, the feedback signal further corresponding to the output signal as frequency translated by the mixer arrangement; and
provide a sequencer input corresponding to the filter output as frequency translated by the mixer arrangement and as modified in accordance with the second feedback signal.

21. The radio frequency power amplifier of claim 20 wherein the loop filter is at least one of a low pass filter and a band pass filter.

22. A radio frequency power amplifier arranged and configured to drive a resonant load comprising:
a radio frequency switching stage with an output that is coupled to a resonant circuit and configured to provide an output signal with amplitude modulation corresponding to amplitude modulation of an input signal when powered from a fixed voltage power supply;
a feedback control system coupled to the input signal and the output signal, the feedback control system comprising a sequencer configured to provide a sequencer output that is used to drive the radio frequency switching stage; and
a second feedback system responsive to the sequencer output and configured to provide a second feedback signal that is coupled to the feedback control system, where the sequencer output has an OFF state that begins at a variable time corresponding to the input signal, the output signal, and the second feedback signal.

23. The radio frequency power amplifier of claim 22 wherein the radio frequency switching stage is further configured to switch ON responsive to the sequencer output so that over a multitude of switch ON events an average voltage imposed on the radio frequency switching stage at the switch ON event is less than ½ of a specified breakdown voltage associated with the radio frequency switching stage.

24. The radio frequency power amplifier of claim 22 wherein the radio frequency switching stage as driven by the sequencer output is further configured to provide an output signal that includes an amplified replica of the input signal over an input signal bandwidth, where the input signal includes complex modulation while the radio frequency switching stage is powered from a constant voltage power supply.

25. The radio frequency power amplifier of claim 22 wherein the second feedback system is configured to couple the second feedback signal to an input of the sequencer.

26. The radio frequency power amplifier of claim 25 wherein the second feedback system provides the second feedback signal comprising a combination of one or more delayed and weighted versions of the sequencer output.

27. The radio frequency power amplifier of claim 26 wherein the second feedback system comprises a plurality of delay stages coupled to a corresponding plurality of gain stages to provide a plurality of delayed and weighted versions of the sequencer output.

28. The radio frequency amplifier of claim 27 wherein the plurality of delay stages comprises a tapped delay line with each tap coupled to a different one of the plurality of gain stages.

29. The radio frequency power amplifier of claim 27 wherein one or more of the plurality of delay stages and one or more of the corresponding plurality of gain stages is operating in continuous time.

30. The radio frequency power amplifier of claim 22 wherein the feedback control system further comprises a loop filter with an output of the loop filter coupled to an input of the sequencer, the loop filter coupled to a signal corresponding to the input signal and the first feedback signal and wherein the second feedback signal is coupled to at least one of the loop filter and the input of the sequencer.

31. The radio frequency power amplifier of claim 30 wherein the second feedback system comprises one or more feedback networks including one or more of a discrete time portion, a continuous time portion, and a memory portion.

32. The radio frequency power amplifier of claim 30 wherein the second feedback system comprises a feedback network coupled from the sequencer output to the sequencer input.

33. The radio frequency power amplifier of claim 30 wherein the second feedback system comprises a feedback network coupled from the sequencer output to the loop filter.

34. The radio frequency power amplifier of claim 22 wherein the sequencer is further configured to provide the sequencer output where the OFF state has a minimum time duration and the sequencer output further has an ON state having a variable time duration.

35. The radio frequency power amplifier of claim 22 wherein the sequencer is configured to provide the sequencer output asynchronously.

36. The radio frequency power amplifier of claim 22 wherein the feedback control system further comprises a loop filter providing a filter output, the filter output modified in accordance with the second feedback signal, and wherein the sequencer further comprises a flip flop clocked from the filter output and configured to provide the sequencer output in the OFF state when triggered by the filter output and in an ON state after a time lapse determined by a Reset signal for the flip flop.

37. The radio frequency power amplifier of claim 22 wherein the feedback control system further comprises a mixer arrangement configured to:
provide a feedback signal, the feedback signal further corresponding to the output signal as down converted by the mixer arrangement; and
provide a sequencer input corresponding to a combination of the input signal and the feedback signal as up converted by the mixer arrangement and as modified by the second feedback signal.

38. A radio frequency power amplifier arranged and configured to drive a resonant load comprising:
a radio frequency switching stage with an output that is coupled to a resonant circuit and configured to provide an output signal with amplitude modulation corresponding to amplitude modulation of an input signal when powered from a fixed voltage power supply;
a feedback control system coupled to the input signal and the output signal, the feedback control system comprising a loop filter providing a filter signal that is coupled to an input of a sequencer, the sequencer configured to provide a sequencer output that is used to drive the radio frequency switching stage; and
a biasing system configured to couple an offset signal to the input of the sequencer, the sequencer output changing states in accordance with the offset signal and the filter signal.

39. A method of providing a radio frequency signal with complex modulation comprising:
filtering a combination of an input signal and a first feedback signal to provide a filtered signal, the input signal including complex modulation;
generating, responsive to the filtered signal, a quantized signal having an OFF state that begins at a variable time;
providing, responsive to the quantized signal, a second feedback signal that is deployed to affect the generating the quantized signal; and
controlling a radio frequency switching stage with the quantized signal to provide an output signal to a resonant load, the output signal comprising an amplified version of the input signal with the complex modulation, the first feedback signal corresponding to the output signal.

40. The method of claim 39 wherein the generating the quantized signal is directly responsive to the second feedback signal.

41. The method of claim 39 wherein the providing the second feedback signal comprises forming one or more delayed and weighted versions of the quantized signal and combining the one or more delayed and weighted versions of the quantized signal to provide the second feedback signal.

42. The method of claim 41 wherein the forming and the combining comprises forming and combining continuously and asynchronously the one or more delayed and weighted versions of the quantized signal.

43. The method of claim 39 wherein the providing the second feedback signal further comprises providing one or more second feedback signals using one or more of a discrete time process, a continuous time process, and a process with memory.

44. The method of claim 39 wherein the providing the second feedback signal further comprises providing a second feedback signal that is deployed to cause the OFF state to begin earlier with the second feedback signal than without the second feedback signal.

45. The method of claim 39 wherein the providing the second feedback signal further comprises providing a second feedback signal that is deployed to cause the OFF state to begin later with the second feedback signal than without the second feedback signal.

46. The method of claim 39 wherein the providing the second feedback signal comprises providing the second feedback signal deployed to affect the variable time to a greater extent when the filtered signal is smaller than when the filtered signal is larger.

47. The method of claim 39 wherein the generating the quantized signal further comprises generating a quantized signal having an ON state with a duration and wherein the providing the second feedback signal comprises providing the second feedback signal deployed to increase a magnitude of a difference between the duration of the ON state and a reference duration.

48. The method of claim 39 wherein the providing the second feedback signal comprises providing the second feedback signal deployed to affect the filtered signal.

49. The method of claim 39 wherein the providing the second feedback signal comprises providing the second feedback signal and combining the second feedback signal with the filtered signal and wherein the generating is further responsive to the second feedback signal.
